(19) United States
(12) Patent Application Publication
(10) Pub. No.: US 2008/0086415 A1
(43) Pub. Date: Apr. 10, 2008

(54) System and Method for Using Credit and Quality Testing for the Procurement and Payment of Goods and Services

(76) Inventors: Karl T. Bubrig, Mandeville, LA (US); Michael J. Oleniczak, Katy, TX (US); Alistair Stubbs, North Vancouver (CA)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/534,468

(22) Filed: Sep. 22, 2006

(51) Int. Cl. G06Q 40/00

(52) U.S. Cl. 705/40

(57) ABSTRACT

The invention relates generally to a method and system for managing the selection, procurement, and payment of goods and services. More specifically, the invention relates to a method for managing procurement and payment of goods and services integrated with both quality assurance services and a payment system to facilitate payment. In an embodiment a merchant and a buyer enter into an order that sets forth an amount and minimum specification of goods or services to be supplied to the buyer, and a price for the amount of goods or service. Goods or services are delivered to the buyer, and a sample is obtained. The sample is tested for at least one factor and test results transmitted to a payment service. Subject to a satisfactory test result the payment service provides payment for the goods or services in accordance with the order and the test results.

### FIELD OF THE INVENTION

The invention relates generally to a method and system for managing the selection, procurement, and payment of products, services, and consumables. More specifically, the invention relates to a method for managing procurement and payment of products, services, and consumables integrated with both third party quality assurance services and a payment system to facilitate payment.

### BACKGROUND OF THE INVENTION

Throughout the world, goods and services are purchased and delivered on a daily basis. The quantities and qualities of the goods, as well as the payment for the goods, however, are sometimes not monitored, measured, or transacted in an efficient or suitable manner. This problem exists in many industries, including the shipping industries, but it is apparent in many other industries and contexts as well. One example of an industry where there is lack of monitoring of quantities, qualities, etc. is marine bunkering, which will be used for non-limiting illustrative purposes below. However, the invention can apply to any industry or context that involves the payment for products, services, or consumables.

Global marine bunkering is a substantial market. In 2003, the market was approximately US$80 billion, and it is anticipated to grow to US$120 billion by 2020. Despite the size of the market, however, current marine bunkering is globally fragmented, suffers a reputation of low quality, lacks transparency, and endures outdated processes for procurement and pricing. A common sentiment among those who work in the industry is that quality assurance in the context of marine fuel supplies has little value.

Maintaining a vessel in a safe operating condition is a complex engineering challenge requiring regular supplies of goods, commodities, and services, for example engine spares, fuel, and inspection services. As the industry is heavily regulated, the quality of the delivered goods, services, and commodities may be important to the smooth running of shipping operations, and failures in the delivered standard may pose risks to the vessel owner, who remains liable for payment for goods and commodities, even when they are not of adequate or suitable standard, and where inadequate goods are used can result in financial and criminal penalties for the owners and operators of the vessels.

As with other fuels, the price of marine fuel has continued to increase, and is expected to remain significantly above its long-term average price. In addition, the establishment of a number of sulfur emission control areas (also called “SECA”) in environmentally sensitive regions will further increase the already growing focus on fuel quality and low sulfur fuels, which may drive prices even higher. Because fuel expenses may comprise approximately half of a ship's daily operating costs, shipping operators are sensitive to marine fuel prices.

Moreover, the impact of poor quality or contaminated fuel may adversely affect the safety and commercial performance of a vessel. Further, bunker prices do not necessarily have a strong correlation with quality. Historically, the quality of marine fuel, specifically residual fuel because its quality is a function of the crude processed at the refinery, has been unpredictable. There are a number of issues with the residual fuel market. For example, while fuel is sold by weight, it is delivered by volume. Because marine fuel often is quite viscous, when substances such as air are entrained within the fuel, it may appear that more fuel is provided in a transaction than actually has been provided, thus resulting in overpayment and underdelivery. Air entrained within fuel results in fuel with a lower overall bulk density. Where air is entrained within the fuel, it may take days for the air to bubble out of the fuel, in which case it may take days to determine just how much fuel was purchased in a given transaction. Even where density is accurately quoted in the purchase of marine fuels, there are many other physical properties that are important to the quality of marine fuels. Low quality fuel may have undesirable levels of sulfur, ash, carbon residue, sediment, vanadium, aluminum and silicon, etc. Such low quality fuel can lead to damaged vessel components such as fuel pumps, cylinder liners, piston rings, and may cause excessive deposits in combustion and exhaust spaces and turbocharger, which may result in requiring replacement of expensive parts, often halting shipping operations and upsetting schedules. Evaluating and agreeing upon the quality of fuel in the context of bunkering has been difficult for buyers and sellers.

Therefore, it would be beneficial to provide products or services that can positively impact the procurement of goods and services in the market place. For example, in the maritime industry, procurement and bunkering managers at shipping companies and fuel suppliers in ports would benefit from a compressive system and method of procuring and funding in the bunker fuel market that provides such functionality as one or more of ensuring the quality of delivered products, including predefined processes for testing and sampling of fuel supplies, combining transaction management and payment services based on standard contracts for supply, providing a predefined process for dispute resolution using an industry recognized arbitration body, offering transparency in performance of the market to suppliers, buyers, and ports, and providing the ability to stabilize fuel prices through a hedging vehicle.

### BRIEF SUMMARY OF THE INVENTION

The invention relates generally to a system and method and system for managing the selection, procurement, third party quality verification and payment of goods or services. More specifically, the invention relates to a system and method for managing procurement and payment of goods services integrated with both quality assurance services and a payment system to facilitate payment.

In one aspect of the present invention, a method is provided for managing fuel procurement and payment services for marine bunkering transactions. A bunker order is established between a fuel merchant and a buyer. The bunker order sets forth an amount of fuel to be supplied to the buyer by the fuel merchant, bunker specifications to be satisfied by the fuel, and a price for the amount of fuel. The fuel merchant delivers the fuel to the buyer, and a fuel test sample is obtained from the delivered fuel. The fuel test sample is transmitted to a bunker surveyor, and the bunker surveyor tests the sample. The surveyor measures at least one bunker factor of the fuel test sample and prepares test results indicating whether the bunker factor satisfies the bunker specifications from the bunker order. The bunker surveyor transmits the test results to a payment service. If the test results indicate that the test sample satisfies the bunker specifications, the payment service electronically provides a payment to the fuel merchant in accordance with the bunker order and bills the buyer for the payment. If the test results indicate that the test sample fails to satisfy the bunker specifications, the payment service waits for notification of a successful resolution between the fuel merchant and the buyer prior to electronically providing the payment to the fuel merchant and billing the buyer for the payment.

Prior to establishing the bunker order, the fuel merchant and the payment service may enter into a merchant agreement setting forth payment terms for the payment to the fuel merchant. The merchant agreement may also set forth testing terms of the testing performed on the test sample by the bunker surveyor.

Also prior to establishing the bunker order, the buyer and the payment service may enter into an account agreement setting forth a line of credit to the buyer for funding the payment to the fuel merchant. The account agreement may also set forth testing terms of the testing performed on the test sample by the bunker surveyor.

In another aspect of the present invention a transaction system for managing fuel procurement and payment services for marine bunkering transactions is provided. The system includes a fuel merchant, a buyer, and a transaction processing system. The fuel merchant and the buyer are in communication to enter into a bunker order for supplying an amount of fuel meeting predefined bunker specifications to the buyer. The transaction processing system is operatively associated with the fuel supplier and the fuel buyer. The transaction processing system is adapted to receive notification of a fuel delivery to the buyer corresponding to the bunker order and to receive test results from a bunker surveyor. The test results include a measurement of at least one bunker factor of a fuel test sample taken from the amount of fuel supplied at the fuel delivery to the buyer. If the measurement of the bunker factor satisfies a predetermined criterion defined by the predefined bunker specifications, the transaction processing system electronically provides a payment to the fuel merchant in accordance with the bunker order and bills the buyer for the payment. If the measurement of the bunker factor does not satisfy the predetermined criterion defined by the predefined bunker specifications, the transaction processing system waits for notification of a resolution between the fuel merchant and the buyer prior to electronically providing the payment to the fuel merchant and billing the buyer for the payment.

### BRIEF DESCRIPTION OF THE DRAWINGS

FIG. 1 is a flow chart diagram showing the process steps of a transaction system between a buyer and a provider in accordance with an embodiment of the present invention.

FIG. 2 is an operation diagram showing the interrelationships between merchants, buyers, payment servicers, testing facilities, and IT (Information Technology) services providers in a system for using credit for refueling in accordance with an embodiment of the present invention.

FIGS. 3A and 3B are flow chart diagrams showing the process steps of using credit for refueling in accordance with one embodiment of the present invention.

FIG. 4 is a diagram of a login screen in an exemplary user interface for the dashboard in accordance with one implementation of the present invention.

FIG. 5 is a diagram of a supplier query screen in an exemplary user interface for the dashboard in accordance with one implementation of the present invention.

FIG. 6 is a diagram of a supplier rating screen in an exemplary user interface for the dashboard in accordance with one implementation of the present invention.

FIG. 7 is a diagram of a supplier comparison screen in an exemplary user interface for the dashboard in accordance with one implementation of the present invention.

FIG. 8 is a quality report screen in an exemplary user interface for the dashboard in accordance with one implementation of the present invention.

FIG. 9 is a bunker sample detail screen in an exemplary user interface for the dashboard in accordance with one implementation of the present invention.

FIG. 10 is a supplier sample analysis screen in an exemplary user interface for the dashboard in accordance with one implementation of the present invention.

FIG. 11 is a port rating screen in an exemplary user interface for the dashboard in accordance with one implementation of the present invention.

FIG. 12 is a port comparison screen in an exemplary user interface for the dashboard in accordance with one implementation of the present invention.

FIG. 13 is a port quality report screen in an exemplary user interface for the dashboard in accordance with one implementation of the present invention.

FIG. 14 is a port sample data screen in an exemplary user interface for the dashboard in accordance with one implementation of the present invention.

FIGS. 15A, 15B, 15C, and 15D are supplier status summary screens in an exemplary user interface for the dashboard in accordance with one implementation of the present invention.

FIGS. 16A and 16B are supplier new offer screens in an exemplary user interface for the dashboard in accordance with one implementation of the present invention.

FIGS. 17A and 17B are supplier draft offer screens in an exemplary user interface for the dashboard in accordance with one implementation of the present invention.

FIGS. 18A and 18B are supplier submitted offer screens in an exemplary user interface for the dashboard in accordance with one implementation of the present invention.

FIGS. 19A and 19B are supplier accepted offer screens in an exemplary user interface for the dashboard in accordance with one implementation of the present invention.

FIGS. 20A and 20B are supplier request change screens in an exemplary user interface for the dashboard in accordance with one implementation of the present invention.

FIG. 21 is a credit authorization screen in an exemplary user interface for the dashboard in accordance with one implementation of the present invention.

FIG. 22 is a testing status summary screen in an exemplary user interface for the dashboard in accordance with one implementation of the present invention.

FIG. 23 is a testing all bunker delivery notes screen in an exemplary user interface for the dashboard in accordance with one implementation of the present invention.

FIG. 24 is a testing bunker delivery notes created screen in an exemplary user interface for the dashboard in accordance with one implementation of the present invention.

FIG. 25 is a testing bunker delivery notes received screen in an exemplary user interface for the dashboard in accordance with one implementation of the present invention.

FIG. 26 is a bunker delivery note test results screen in an exemplary user interface for the dashboard in accordance with one implementation of the present invention.

### DETAILED DESCRIPTION OF THE INVENTION

System Overview

The system and method of the present invention provide for various entities that operate with one another by the terms of predefined agreements and by using communication technologies, systems applications, and/or databases to facilitate desired operations. For example, in an embodiment of the invention that is used in the context of the shipping industry, the system and method may facilitate the research, delivery, testing, payments, and/or billing relating to marine-related transactions, such as fuel or other transactions, for shipping entities. In another embodiment of the invention, the system and method may be used in the context of providing any goods or services where there is a quality assurance aspect.

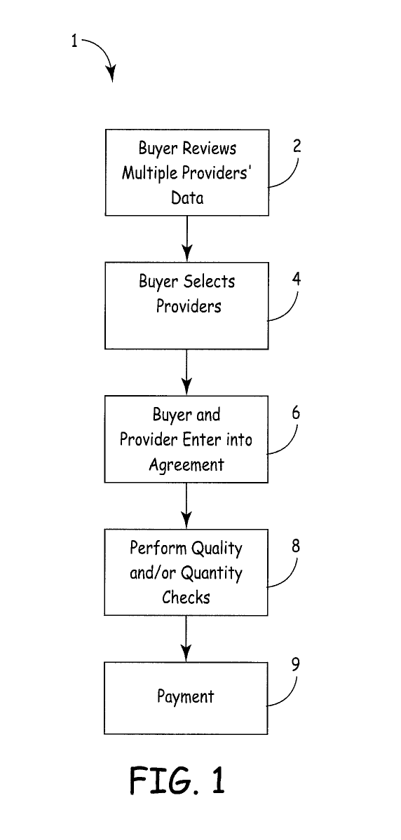

Referring to FIG. 1, one embodiment of a transaction system 1 between a buyer and a provider is shown. The system 1 has a buyer that reviews one or more providers' data, step 2. In one embodiment, the buyer uses a dashboard system 22 described below to review the one or more providers' data. In another embodiment, the buyer contacts one or more providers and requests the relevant data from each of the contacted providers. In one embodiment, the buyer can filter the one or more providers' data to get a smaller list of providers. The provider data can be any data that is relevant to the particular business or industry, including cost, quantity, previous quantities sold, quality, previous quality ratings, delivery time, product description, etc. The buyer selects a particular provider from the one or more providers reviewed, step 4. The buyer can make this selection either through the dashboard system 22 described below, or any number of ways including directly contacting them. The buyer and provider may enter into an agreement regarding the services or goods that the buyer is requesting, step 6.

In one embodiment of the present invention, the agreement is in the form of a bunker contract 30 described below. In other embodiments, the agreement may be for products or services in any industry where a quality component is provided as part of the procurement process. In still other embodiments, the agreement may relate to products or services in the marine industry. In one embodiment used in the marine industry, the agreement can set forth the cost of the goods and services, the time for delivery, the quantity, the quality, and any other relevant terms that the buyer and provider deem appropriate. The buyer, provider, or some third party performs quality, quantity, or some form of test that measures acceptability of the goods or services to be provided by the provider to the buyer, step 8. In one embodiment, the quality and/or quantity check is performed by a testing facility 18 described below. The quality and/or quantity check can be based on an agreement between the buyer and provider, or it can be based on International Organization for Standardization (ISO) standards, other objective criteria, or on any standards agreed to or settled upon by other means. If the goods or services pass the quality and/or quantity check, the buyer makes a payment either directly or indirectly to the provider, step 9. By linking payment to this quality and/or quantity check, the risk of failure for supply of inadequate goods, consumables, and services is shared generally equally between the supplying parties (providers) who are making the quality claims and the consuming parties (buyers) who need a specific quality. In one embodiment, the payment is accomplished through the use of a payment servicer 16 described below. The transaction system 1 can be applied to any and all industries and contexts where there is a buyer and a provider conducting business. In the following description reference is made to refueling, but it is for illustration purposes only and is not intended to limit the scope of this invention.

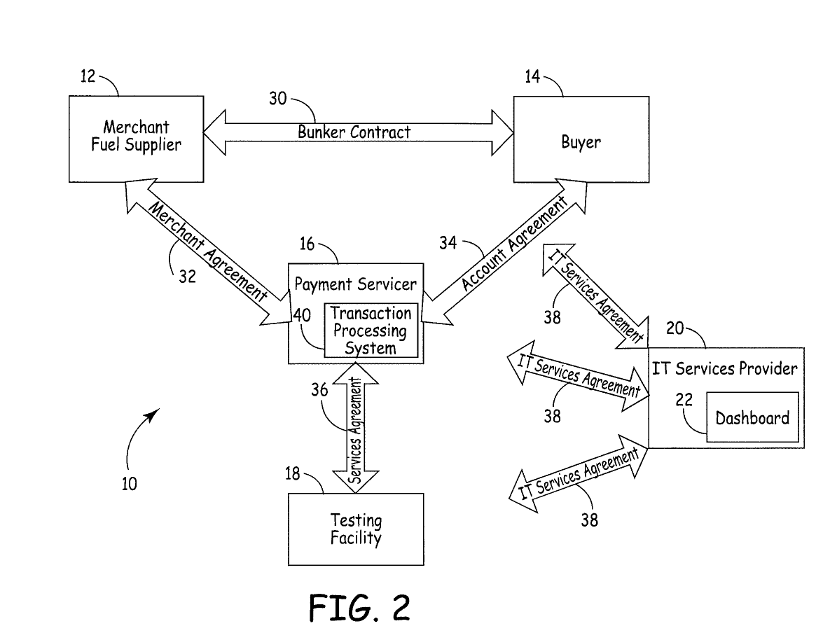

Referring to FIG. 2, one embodiment of a system 10 for using credit for refueling is shown. The system 10 and process of using credit for refueling may include a merchant 12 or other fuel supplier, a buyer 14, a payment servicer 16 or other entity that provides a payment system or otherwise facilitates payment functionality, and a testing facility 18. In this embodiment, the merchant, the buyer, the payment servicer, and the testing facility are distinct entities that enter into agreements that describe each party's roles and responsibilities in the process. Other embodiments within the scope of the present invention provide for a single entity performing the functions of one or more of the merchant 12, the buyer 14, the payment servicer 16, and the testing facility 18. Still other embodiments provide for the responsibilities of any one of these entities being performed by more than one entity, or one or more entities sharing one or more of these responsibilities. The terms merchant 12, buyer 14, payment servicer 16, and testing facility 18 include but are not limited to agents acting on behalf of these respective entities. Additional entities may be involved in the process, such as barge operators, brokers, and vessel charterers, and the system and method may be applied at deeper levels, or any suitable levels, into the fuel supply chain. The system and method also may be applied across other services, from port dues to basic supplies, etc.

The relevant entities each perform specified roles in the process, which may be delineated by the agreements and relationships shown in FIG. 2. In one embodiment, where the process is a refueling process, the payment servicer 16 extends credit to buyers 14 for purposes of purchasing fuel or other shipping goods or services in accordance with an account agreement 34. The account agreement 34 between the payment servicer 16 and the buyers 14 may be a credit agreement that extends a line of credit (LOC) to the buyer. For example, the servicer may extend any appropriate LOC to a buyer 14, such as a LOC up to US $100 million to a buyer 14. Buyers in the shipping industry often require a LOC up to US $100 million or even higher. Any lower LOC also may be appropriate. The specific LOC may depend upon such factors as the demands and credit worthiness of the buyer, the ability and capacity of the servicer, the specific nature of the transactions to be within the LOC, etc. In addition to extending credit to a buyer, the account agreement 34 may include provisions governing fuel testing, including identification of a particular testing facility, a testing method, and a testing location (e.g., vessel manifold). The account agreement 34 also may include general or specific parameters relating to specifications for certain properties of the fuel. In addition, the account agreement 34 may include any other suitable or desired provisions. One of the entities, such as the payment servicer 16, also may provide and operate a transaction processing system 40 that electronically facilitates the lending and payment functionality of the present system. The transaction processing system 40 may be an electronically networked system that is accessible by some or all of the merchant 12, the buyer 14, the testing facility 18, and the payment servicer 40, as is described in more detail herein.

Payments that are made by the payment servicer 16 to merchant 12 may be made pursuant to a merchant agreement 32. The merchant 12 may be a fuel supplier such as a bunker supplier or other entity that may act to sell or agree to sell fuel or other products or services related to shipping, transportation, or fleet management. The merchant agreement 32 between the payment servicer 16 and the merchant 12 may provide for payment terms and may also include any other provisions, such as those governing fuel testing, including identification of a particular testing facility, a testing method, a testing location, general or specific fuel specifications, etc.

Maritime law may provide protection to lenders such as payment servicer 16 by establishing lien provisions for non-payment of supplies used in vessels, including fuel. However, because such laws vary in different parts of the world and may depend on where a particular vessel is flagged, standard account agreements 34 between the payment servicer 16 and the buyers 14 and standard merchant agreements 32 between the servicer 16 and the merchant 12 may be modified to incorporate appropriate lien provisions. These agreements also may be modified, or provided in general or specific forms, to account for other provisions that may vary, such as based on other regional or national laws or regulations, type of vessel at issue, nature of transportation routes (e.g., solely domestic, entirely international travel, or a mix), or any other characteristic of a relationship that may make variable or multiple agreements desirable.

Referring again to FIG. 2, the payment servicer 16 may enter into a testing services agreement 36 with a testing facility 18. In one embodiment, the testing facility 18 may be a bunker surveyor. The payment servicer 16 may be well-situated to engage the testing facility 18, because the servicer may control payments to the merchant 12 and extend credit to the buyer 14. In other embodiments of the present invention, different or multiple entities may engage the testing facility 18. For example, the merchant 12 or the buyer 14 may contract with the testing facility 18. The testing services agreement 36 may include provisions relating to testing facilities, testing methods, and random quantity surveys. In one embodiment, the testing services may include a fuel analysis, which may test the fuel to determine compliance with any number of agreed-upon specifications for any of the various applicable characteristics of the fuel. Any suitable fuel analysis may be used, including the Fuel Oil and Bunker Analysis and Advisory Service (FOBAS) provided by LLOYD'S REGISTER. The testing facility 18 analyzes a fuel sample to ensure that the delivered fuel meets the promised bunker specifications. The cost of the testing may be incorporated into the negotiated fuel cost, incorporated with transaction costs associated with the payment servicer 16, paid separately or directly by the buyer 14, or addressed in any other suitable manner.

As described in more detail herein, in operation the merchant 12 and buyer 14 may enter into an agreement for a transaction whereby the merchant provides an amount of fuel to the buyer for a determined price. The price may be specific, or it may vary. Where the price varies, it may be based on any appropriate variables, including the fuel's properties, or any other suitable variable. Where the fuel price varies based on the fuel's properties, the price may be determined in any suitable manner, such as by evaluating results that test one or more properties of the fuel, by evaluating compliance with specifications, etc. The terms of the agreement are prescribed by the bunker contract 30, which may be entered into by the merchant 12 and buyer 14 for each individual fueling occurrence. In other embodiments, the merchant 12 and buyer 14 may agree to terms that are applicable to multiple transactions. Standard forms may be provided, for example by the payment servicer 16, to structure the bunker contract 30, including a bunker order and a bunker delivery note (BDN). The bunker order may stipulate one or more of fuel grade, fuel quantity, agreed-upon price, delivery point and terms (including loading rate), and other bunker requirements. As described below, the BDN is signed upon completion of delivery to the buyer and indicates the actual quantity of fuel delivered, the assumed density, and seal numbers for test samples taken at the time of delivery.

IT services provider 20 may enter into one or more IT services agreements 38 with the testing facility 18, the payment servicer 16, or any other entity, whereby the IT services provider 20 makes available facilities such as a networked system that connects the appropriate entities. In one embodiment, the IT services provider 20 supports and maintains a business process management interface, such as a dashboard system 22. In one embodiment, dashboard 22 is a website or other networked interface that communicates with software applications and databases and is accessible to the relevant entities. The dashboard 22 may receive requests via a user interface and produce reports responsive to such requests, as described herein. The dashboard also may contain links to subsidiary management and reporting applications, as is helpful or necessary to provide the functionality described below. The IT services provider 20 optionally may interface the dashboard system 22 with the transaction processing system 40, allowing the two systems to share data as needed.

Transaction Processing System

In addition to providing lending and other banking or banking-type services and functionality, the payment servicer 16 also may provide and operate the transaction processing system 40, which electronically facilitates the lending, hedging, and payment functionality of the system 10 for using credit for refueling. In alterative embodiments of the present invention, the banking services and the transaction processing system may be provided by other, multiple, or separate entities.

The transaction processing system 40 provides merchants with an efficient, cost-effective method of accepting customized transaction cards, credit cards, debit cards, and any other instrument suitable for transferring funds or credit. In one embodiment, a customized transaction card may be offered to buyers by the payment servicer 16 or other entity for use with the transaction processing system 40. Such a card may have broad functionality, or it may be tailored to the fuel industry, such as by providing fuel card tracking and reporting functionality, including reporting of tax exemption statuses, discount processing, online system access, card level control, and any other desired information. The customized transaction card may be assigned to individuals, ships or vehicles, corporate departments and divisions, or other suitable entities. The card may provide one or more of point-of-sale prompting, card level exception reporting, purchase control parameters, reporting products that allows fleet managers to manage their fuel programs, etc. While some embodiments of the invention are described with respect to a transaction card, it is to be understood that the invention is not so limited, and, where an instrument is desirable or appropriate, any suitable instrument may be used.

In one embodiment of the present invention, merchants 12 may enter into merchant agreements 32 to accept and transfer funds or credit with the customized transaction card through the transaction processing system 40. Prior to entering into a merchant agreement, the payment servicer 16 may require that merchants 12 apply to become credit qualified according to standards deemed suitable to the lending division of the payment servicer 16. For instance, the payment servicer 16 may perform a check with the Office of Foreign Asset Control (OFAC) of the U.S. Department of Treasury. Where a credit verification or check is deemed necessary or appropriate, any suitable credit verification or check, as determined by the payment servicer 16, may be performed.

Any suitable transaction processing system 40 may be used. In one embodiment, the transaction processing system 40 may be electronic, thereby avoiding the need for traditional paper-based system infrastructure. The system is configured for maintenance and service merchants; the system provides merchants 12 with an electronic channel for accepting a customized transaction card without purchasing new equipment and without lengthy system migration processes.

Where a card or other designated instrument is used, the maintenance and service providers may accept the card from buyers 12 in any appropriate manner, including electronically. In operation in one embodiment, a buyer 14 using a customized transaction card may provide a customized transaction card number or other identifying information or an object to a merchant 12, but the merchant may request pre-authorization through the transaction processing system 40 before the buyer requests payment to the merchant 12 from the payment servicer 16. In one embodiment, the merchant 12 does not request funding from the payment servicer 16 and does not receive payment from the payment servicer 16 until the buyer 14 creates a purchase order in the transaction processing system 40. The merchant 12 may receive confirmation when the purchase order has been created in the system. Additionally, in one embodiment, the payment servicer 16 does not provide payment to a merchant 12 through the transaction processing system 40 until the quality of the delivered fuel has been independently tested by having a fuel test sample analyzed. In other embodiments, pre-authorization may not be used or deemed necessary or appropriate, purchase orders are not used, and/or payment is delivered independently of the fuel test sample analysis.

Dashboard System

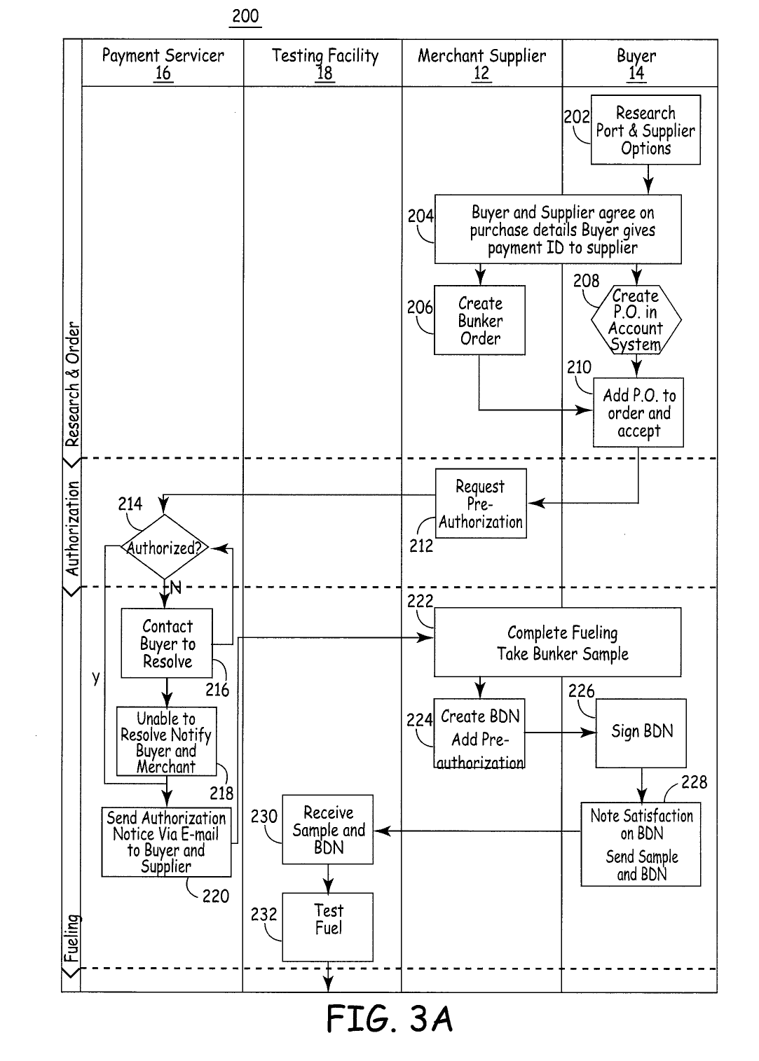

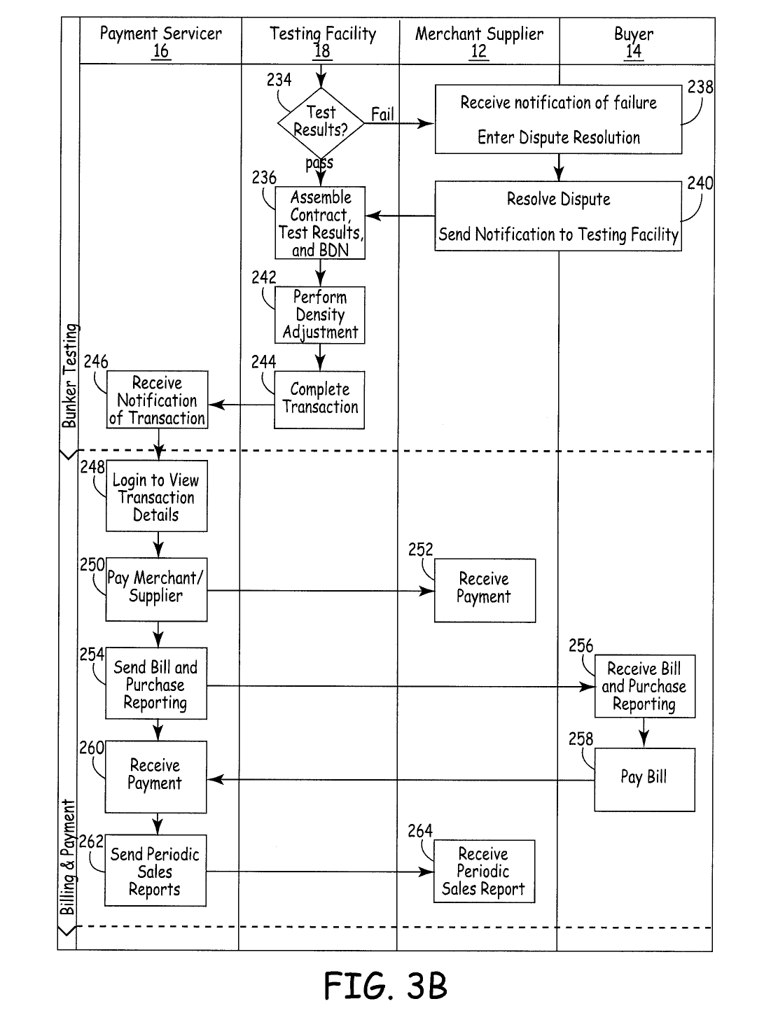

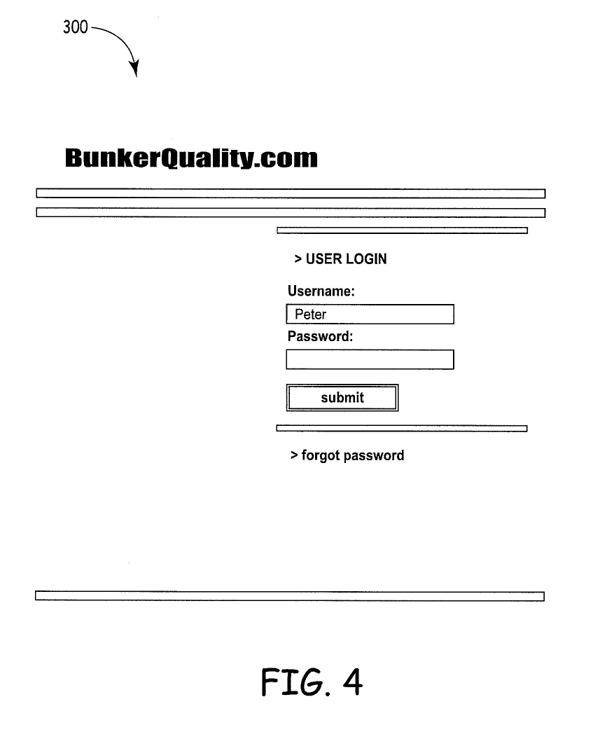

FIGS. 3A and 3B depict flow chart diagrams showing the process steps of using credit for refueling 200 in accordance with one embodiment of the present invention. As shown in FIGS. 3A and 3B, in operation a buyer 14 seeking to refuel may initiate the process by researching port and merchant-supplier options, step 202. In one embodiment, the dashboard system 22 provides a user interface to the buyer 14 that facilitates the bunker research. As described above, the interface may be a website portal. FIG. 4 is an example of a diagram of a login screen 300 in an exemplary user interface for the dashboard 22 in accordance with one implementation of the present invention. (FIGS. 3A and 3B will be discussed in further detail below.) Where the buyer-user uses the login screen, the buyer-user of the dashboard will login, and the dashboard system 22 verifies the user's credentials, if appropriate. Where a login screen is not used, the dashboard system 22 may verify the user's credentials or identity as appropriate. While screens are depicted, for illustrative purposes only, of some aspects of the present invention, it is to be understood that the presence or absence of an illustrative screen or interface herein is not to be construed as limiting the scope of the present invention.

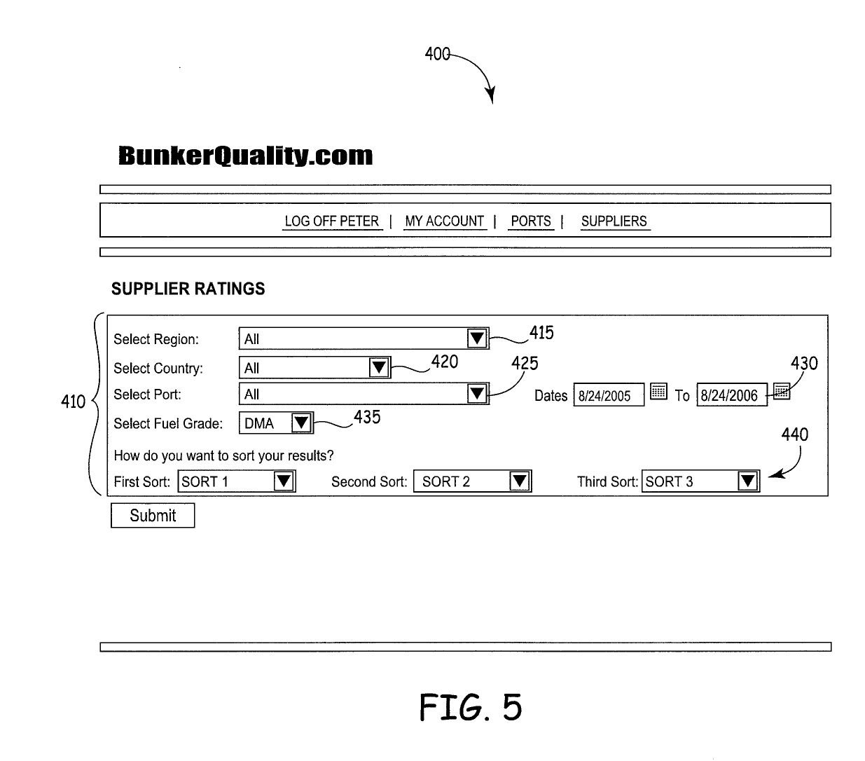

Next, the buyer-user may interact with the dashboard 22 to identify fueling choices and view and identify certified fuel merchants 12. FIG. 5 is an example of a diagram of a supplier query screen 400 in accordance with one implementation of the present invention that is displayed to the buyer-user. From the supplier query screen 400, the buyer-user may select and submit desired merchant search criteria 410 to identify suitable fuel suppliers.

Any suitable merchant search criteria may be used. Such merchant search criteria may include, without limitation, region, country, port, available dates, and/or fuel grade, etc. The region may be selected by the buyer-user in a region field 415, which may include an editable field or a drop-down box containing various selectable geographic regions. For example, where the region field 415 is a drop-down box, the selectable contents of the field may include “Central American East Coast and Caribbean,” “Central American West Coast,” “East Africa,”“East Asia,” “Mediterranean Europe,” “Middle East,” “North Africa,” “North American East Coast,” “North American Great Lakes,” “North American Gulf Coast,” “North American West Coast,” “North Europe Atlantic and Baltic,” “Oceania,” “Pacific,” “South American East Coast,” “South American West Coast,” “South Asia,” “South East Asia, “South Europe Atlantic,” “South Europe Black Sea,” “Southern Africa,” and/or “West Africa,” or other geographically descriptive regions. Similarly, the desired country and port may be indicated by the buyer-user in a country field 420 and a port field 425 respectively. The country field 420 and the port field 425 may include editable fields or drop-down boxes containing predetermined options. The buyer-user may edit date fields 430 to indicate a desired date range of fuel delivery and may edit a fuel grade field 435 to indicate a desired fuel grade. Suitable fuel grades for fuel grade field 435 may include, without limitation, “DMA,” “DMB,” “DMC,” “RMA10,” “RMA30,” “RMB10,” “RMC10,” 37 RMD15,” “RMD80,” “RME180,” “RME25,” “RMF180,” “RMF25,” “RMG35,” “RMG380,” “RMH35,” “RMH45,” “RMH55,” “RMH700,” “RMK35,” “RMK380,” “RMK45,” and/or “RMK55,” etc. Any or all of the afore-mentioned fields may be limited to some or all of the options identified, or the fields may be provided with an option such as “all” that displays all relevant information. Finally, sorting fields 440 may be provided, so that the buyer-user may edit sorting fields 440 to indicate a desired sorting for the merchant search results.

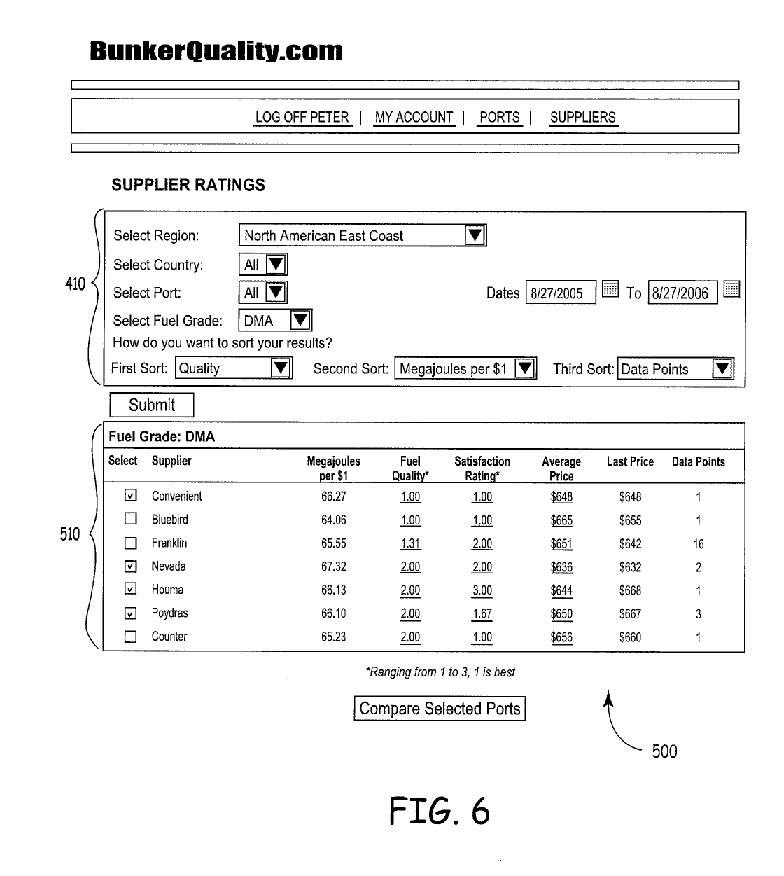

Responsive to submission of the desired merchant criteria selected by the buyer-user, the dashboard 22 may execute a query on a supplier database, and may display the results 510 on a supplier rating screen 500, an example of which is shown in FIG. 6. Results also may be provided in other suitable electronic and paper forms. From the supplier rating screen 500, the buyer-user may modify the merchant search criteria 410 to expand or narrow the results, or the buyer-user may select a fuel supplier from the results list 510. Supplier results may be processed or analyzed in any suitable manner. For example, the supplier results may be selected individually, for example with a hyperlink, to view a quality report for the selected supplier, or multiple supplier results may be tagged, for example with a checkbox, and compared, etc. Responsive to submission of multiple tagged suppliers selected by the buyer-user, the dashboard 22 may retrieve additional supplier information 610 from the supplier database, and display the information 610 on a supplier comparison screen 600.

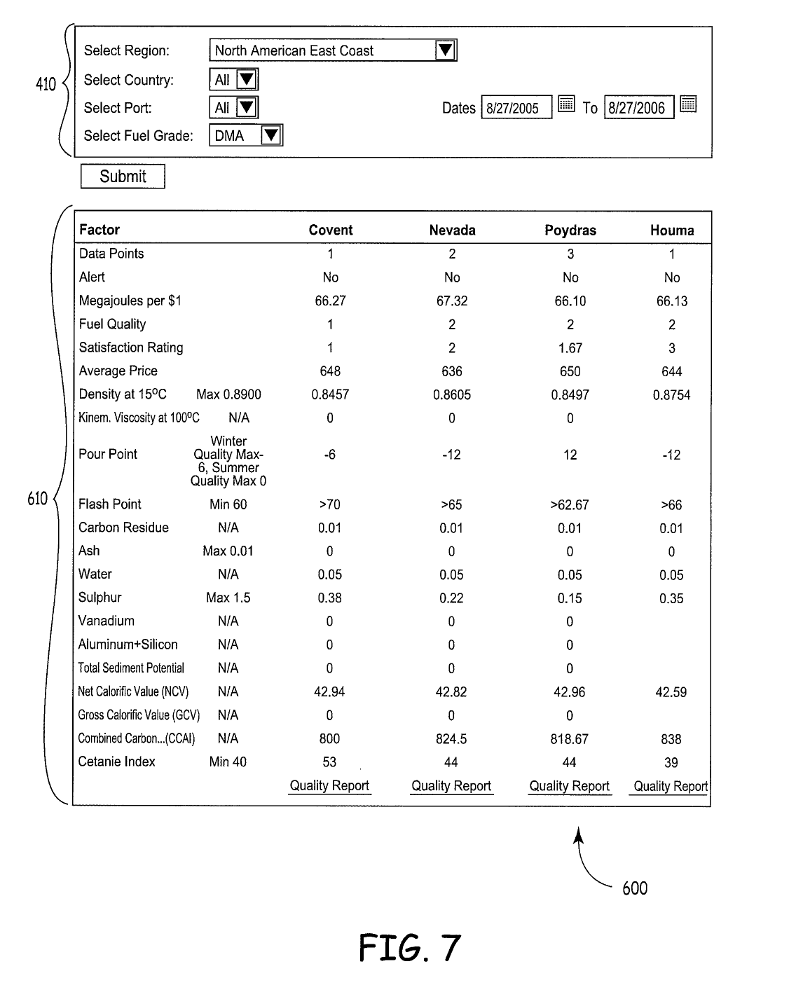

One example of a supplier comparison screen 600 that may be used is shown, for illustrative purposes only, in FIG. 7. The supplier comparison screen 600 displays the tagged suppliers and their corresponding supplier information 610, which includes bunker factors that may incorporate, without limitation, a number of data points, alerts, megajoules per $1, fuel quality, satisfaction rating, average price, density at 15° C., kinematic viscosity at 100° C., pour point, flash point, carbon residue, ash content, water content, sulfur content, vanadium content, aluminum and silicon content, total sediment potential, net calorific value, gross calorific value, combined carbon aromaticity index, cetane index, other suitable information, and combinations or subsets of bunker factors. Where applicable, the supplier comparison screen 600 may display the ISO values or ranges for the displayed bunker factors, which may present a point of reference to the buyer-user.

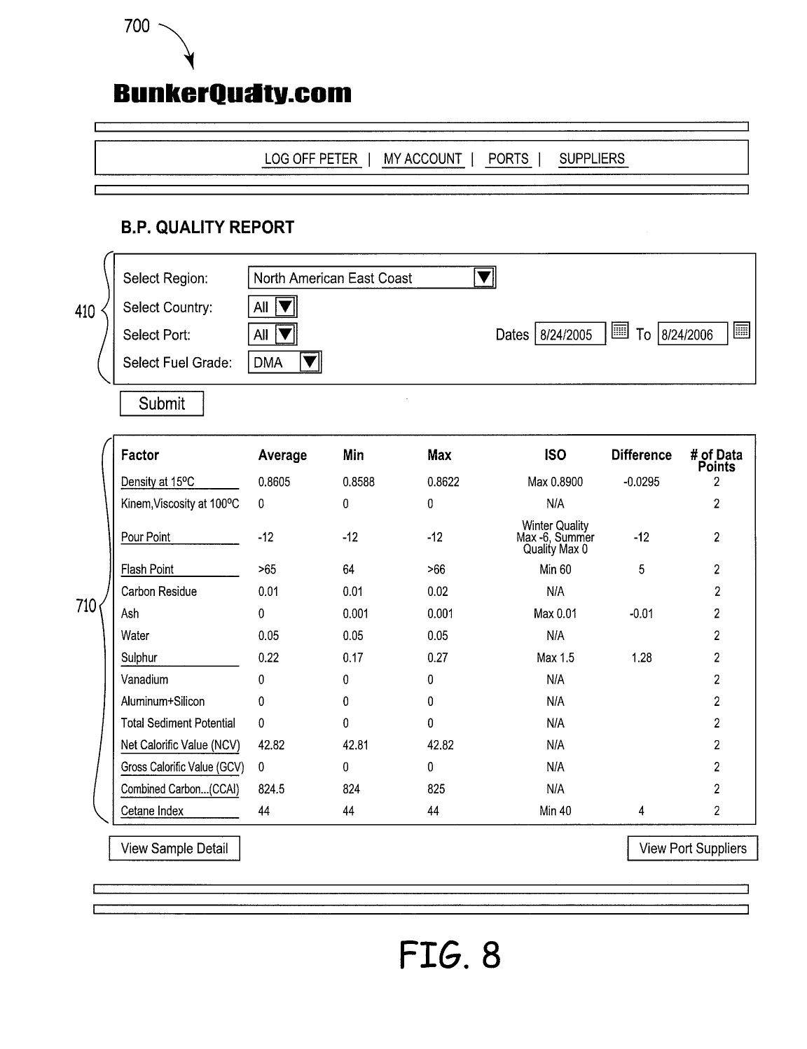

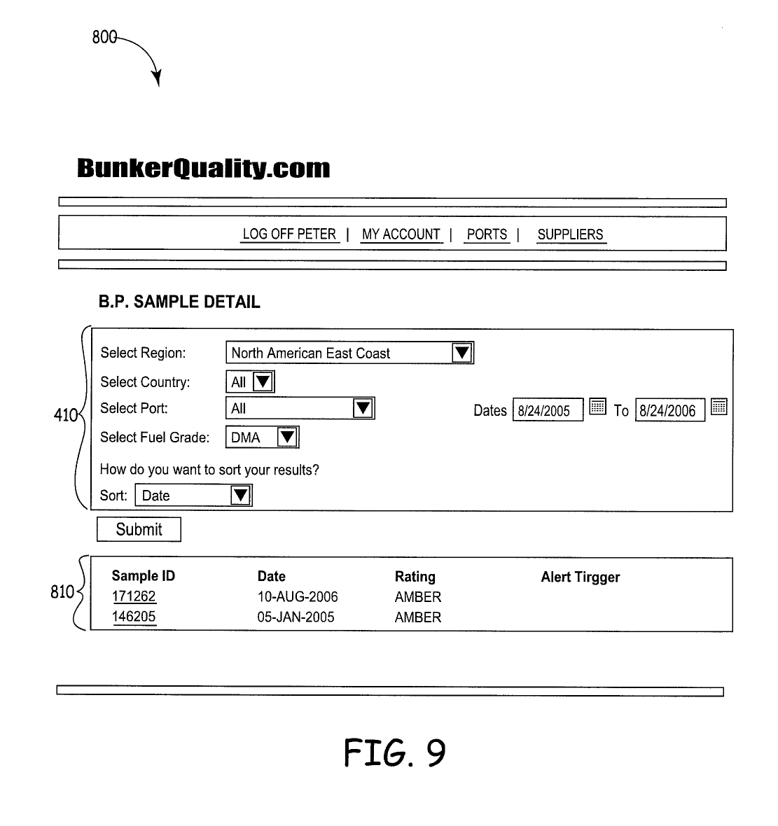

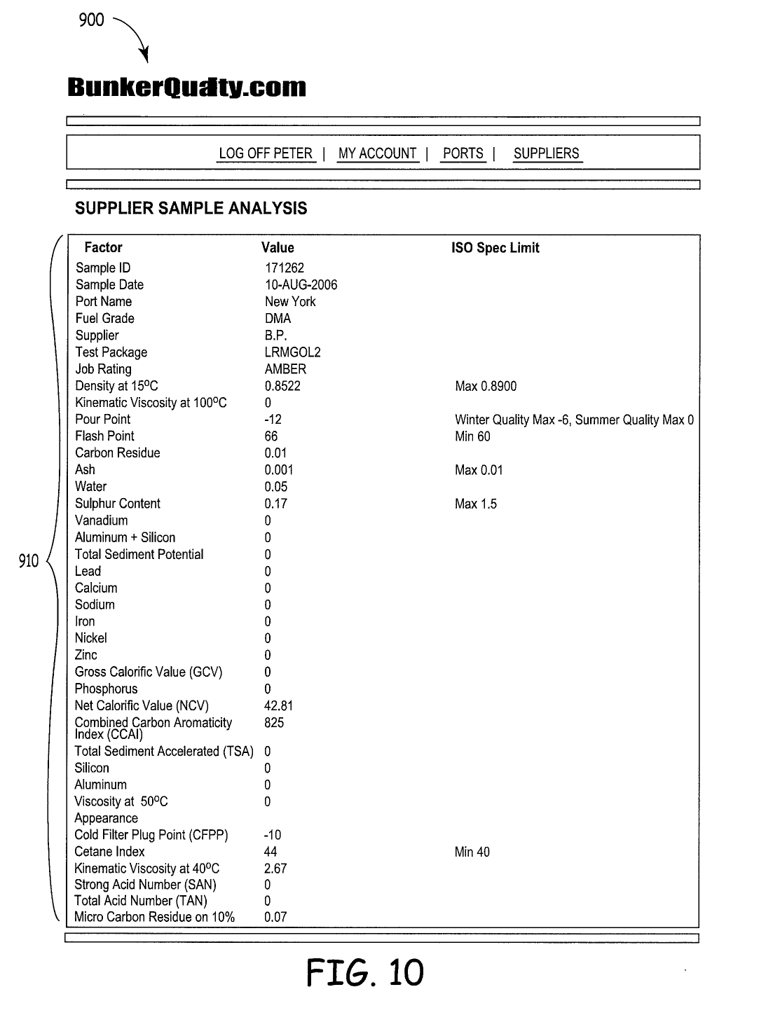

The buyer-user may select a supplier hyperlink from either the supplier rating screen 500 or the supplier comparison screen 600 to view a quality report for a desired supplier, responsive to which the dashboard 22 may retrieve quality report data and display a quality report screen 700 for the desired supplier. One example of a quality report screen 700 for a desired supplier is shown, for illustrative purposes only, in FIG. 8. The quality report 710 may include any relevant data selected. For example, the quality report 710 may display the data relating to the bunker factors displayed in the supplier information 610. The quality report 710 may display an average value, a minimum value, a maximum value, the ISO value, a difference between the ISO value and the average value, a number of data points, or other information, or combinations or subsets of these, for each of the bunker factors displayed. Additionally, a buyer-user may request to view sample details, such as from quality report screen 700, responsive to which the dashboard retrieves previous samples corresponding to the selected supplier and displays a bunker sample detail screen 800. FIG. 9 shows one example of a bunker sample detail screen 800. As with all examples provided herein, the example of FIG. 9 is provided for illustrative purposes only. The sample detail screen 800 includes a list 810 of sample ID's, each sample ID identifying and being correlated to a bunker sample previously taken from the selected supplier. The buyer-user may select, for example with a hyperlink, a desired sample ID, responsive to which the dashboard retrieves sample data and displays a supplier sample analysis screen 900, an example of which is seen in FIG. 10.

The sample analysis 910 may include bunker data incorporating, without limitation, sample ID, sample date, port name, fuel grade, supplier, test package, job rating, density at 15° C., kinematic viscosity at 100 C, pour point, flash point, carbon residue, ash, water, sulfur content, vanadium, aluminum and silicon, total sediment potential, lead, calcium, sodium, iron, nickel, zinc, gross calorific value, phosphorus, net calorific value, combined carbon aromaticity index, total sediment accelerated, silicon, aluminum, viscosity at 50 C, appearance, cold filter plug point, cetane index, kinematic viscosity at 40 C, strong acid number, total acid number, micro carbon residue on 10%, other information of interest, or combinations of subsets of these. Where applicable, an ISO standard or limit for each of the foregoing bunker metrics may be displayed to provide a quality gauge. The bunker metrics may be adapted to include additional, or fewer, metrics as various bunker factors are deemed more or less useful in assessing the quality or desirability of fuel.

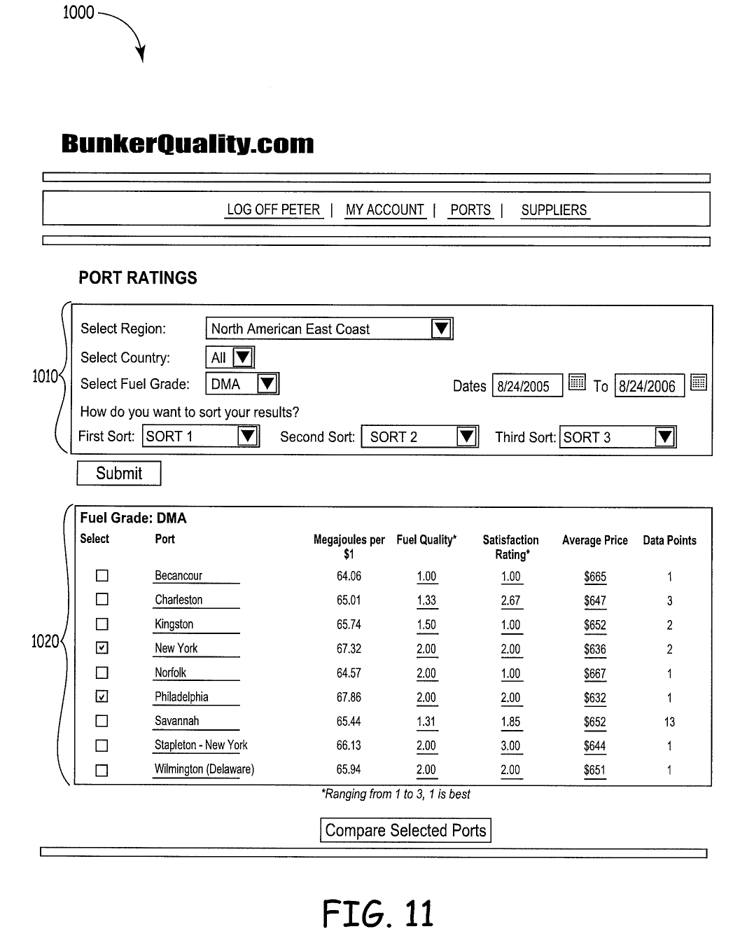

In another embodiment, rather than the buyer-user initially searching and researching by supplier, the dashboard 22 may allow the buyer-user to conduct comparable research by port. This functionality may be valuable to buyers that desire refueling at one or more specific ports. Upon selection by the buyer-user, the dashboard 22 may display a port rating screen 1000. FIG. 11 shows one example of a port rating screen 1000, which may display data relating to all available ports in a port list 1020. The buyer-user may interact with a port search criteria region 1010 to select and submit desired port search criteria to filter the port list 1020 down to suitable ports for the buyer by narrowing the search criteria. Such criteria may include, without limitation, region, country, available dates, and fuel grade.

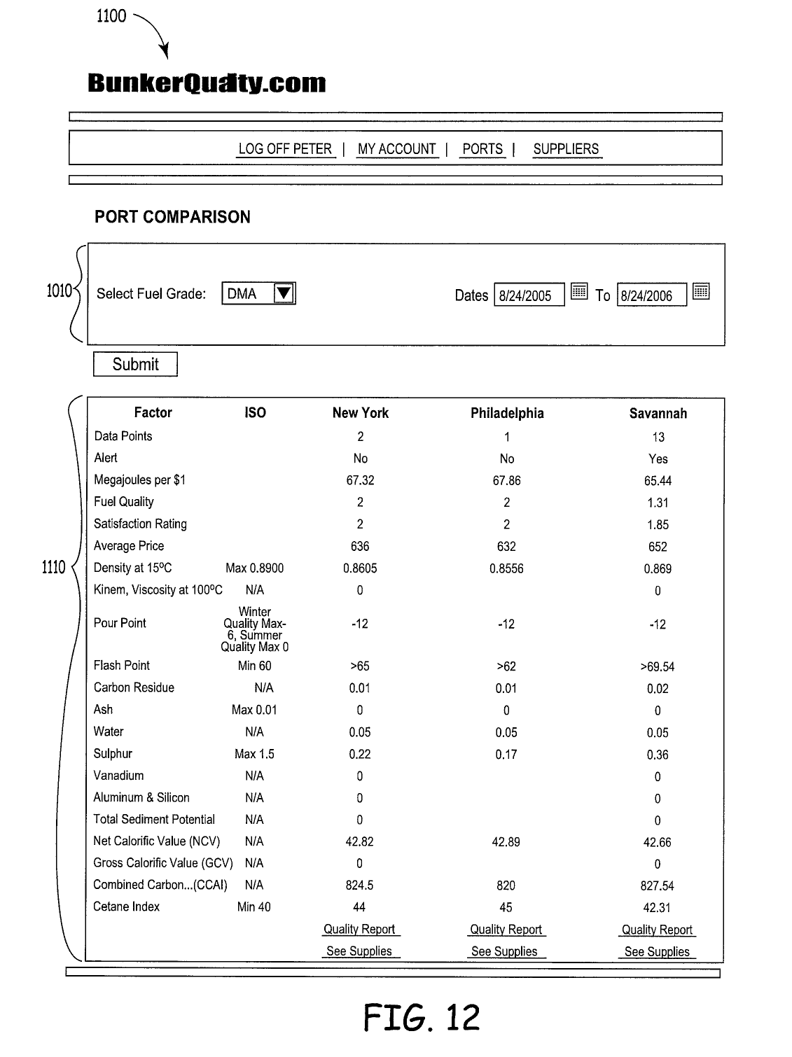

The ports on the port list 1020 may be selected individually, for example with a hyperlink, to view a quality report for the selected port, or multiple ports may be tagged, for example with a checkbox, and then compared. Referring to FIG. 12, which shows one example of a port comparison screen 1100, responsive to submission of multiple tagged ports selected by the buyer-user, the dashboard 22 may retrieve additional port information 1110 from the supplier database and display the port information 1110 on the port comparison screen 1100. The port comparison screen 1100 displays the tagged ports and their corresponding port information 1110, which includes the desired bunker factors, which may be similar to the bunker factors displayed in the supplier information 610 on the supplier comparison screen 600.

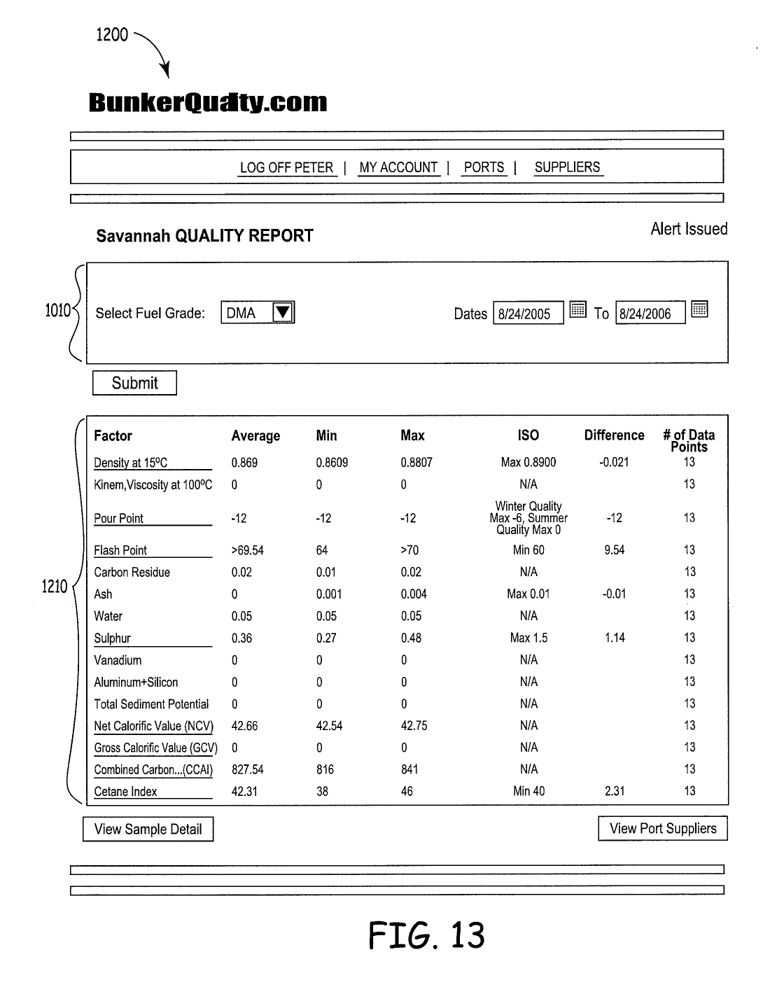

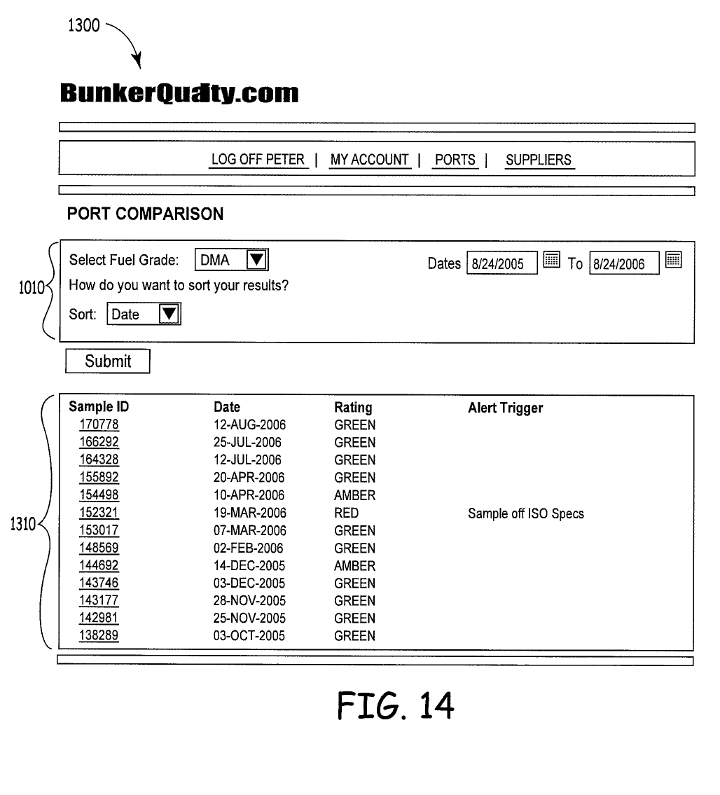

The buyer-user may select a port hyperlink from either the port rating screen 1000 or the port comparison screen 1100 in order to view a quality report for a desired port, responsive to which the dashboard 22 retrieves quality report data and displays a port quality report screen 1200 for the desired port, one example of which is shown, for purposes of illustration only, in FIG. 13. The quality report 1210 may include data relating to the bunker factors displayed in the quality report 710. The buyer-user may select to view sample data from the dashboard 22, responsive to which the dashboard displays a port sample data screen 1300. An example of a port sample data screen 1300 is depicted in FIG. 14. The port sample data screen 1300 may include a sample list 1310 that includes a listing of samples, each sample identified by a sample ID number, a date of the sample, a rating of the sample, an alert indicator, which may provide information identifying samples that did not meet a specified standard, other relevant information, or combinations or subsets of these. The samples may be selectable, for example by a hyperlink, to retrieve additional information relating to the sample. Responsive to selection of a sample, the dashboard 22 may display a sample analysis screen 900 with the sample analysis 910 bunker data for the selected sample.

Process Flow for Marine Fueling

Returning to FIGS. 3A and 3B, once the buyer 14 has satisfactorily researched port and merchant-supplier options, step 202, the buyer selects a merchant 12. In other embodiments, the dashboard 22 may either select or recommend a merchant 12 for or to the buyer 14, with or without the buyer 14 doing research. Such a selection or recommendation may be made pursuant to input from the buyer 14, such as the relative importance of various factors such as price, quality, and location, or the system may use one or more predetermined formulas to rank available options for the buyer 14. In another embodiment, the dashboard 22 may rank merchants 12 in various categories, so that the buyer 14 may see which merchant 12 may be preferred where the priorities are, for example, price, then quality, then location, or where the priorities of the buyer 14 are instead, for example, quality, then location, then quantity available, then price. In some embodiments, the dashboard 22 may determine that it would be advantageous to purchase some quantity of fuel from one merchant 12, and some additional quantity or quantities from another merchant 12 or other merchants 12. Any other method for selecting or recommending a merchant 12 or merchants 12 also may be used.

After determining which merchant 12 (or merchants 12) to deal with, the buyer 14 may engage the selected merchant 12 to negotiate a fuel purchase for a desired bunker quantity at a desired port. The buyer 14 may contact the merchant 12 through traditional means, including telephone, facsimile, postal mail, electronic mail, or other standard communication means. Alternatively, the buyer may contact the selected vendor through the dashboard system 22, which may facilitate electronic communications between the buyer and the merchant. The buyer 14 and merchant 12, or agents for the buyer or merchant, may negotiate the terms of the bunker agreement, including quantity, quality, refueling date, and port, and reach an agreement, step 204. Upon agreement, the buyer 14 may provide a payment servicer account number such as a number from a customized transaction card, or payment ID, to the merchant 12. The merchant 12, the buyer 14, or both the merchant 12 and the buyer 14 may interact with the dashboard 22 to create a fuel supply contract using the standardized forms. In cases where the standardized forms need to be modified, for example, to reflect negotiated terms between the parties or to conform to local or regional laws, the dashboard 22 provides the standardized forms in a format that either party may modify. The fueling may be scheduled by the parties as part of the agreement.

In other embodiments, direct negotiation between the merchant 12 and the buyer 14 are not used. For example, the dashboard 22 may allow the buyer 14 to purchase from the merchant 12 at predetermined terms. In one embodiment, the dashboard 22 may permit a buyer 14 to accept an offer from a merchant 12 (with some or all terms set forth), or it may permit a merchant 12 to accept an offer from a buyer 14 (with some or all terms set forth). Such acceptance may be accomplished in any suitable manner, such as clicking on a hyperlink, checking a box, providing transaction confirmation such as a card number, etc. This function may be combined with the dashboard 22 selecting or providing a merchant 12 for a buyer 14. The dashboard 22 also may facilitate any negotiations between merchant 12 and buyer 14. Such negotiations may be without any predetermined terms. Alternatively, the negotiations may proceed with some or all of the terms set in advance, or with some of all of the terms limited to specific options, or with some or all of the terms bundled together into partial or complete agreements that the merchant 12 and buyer 14 may select, or in any other suitable manner.

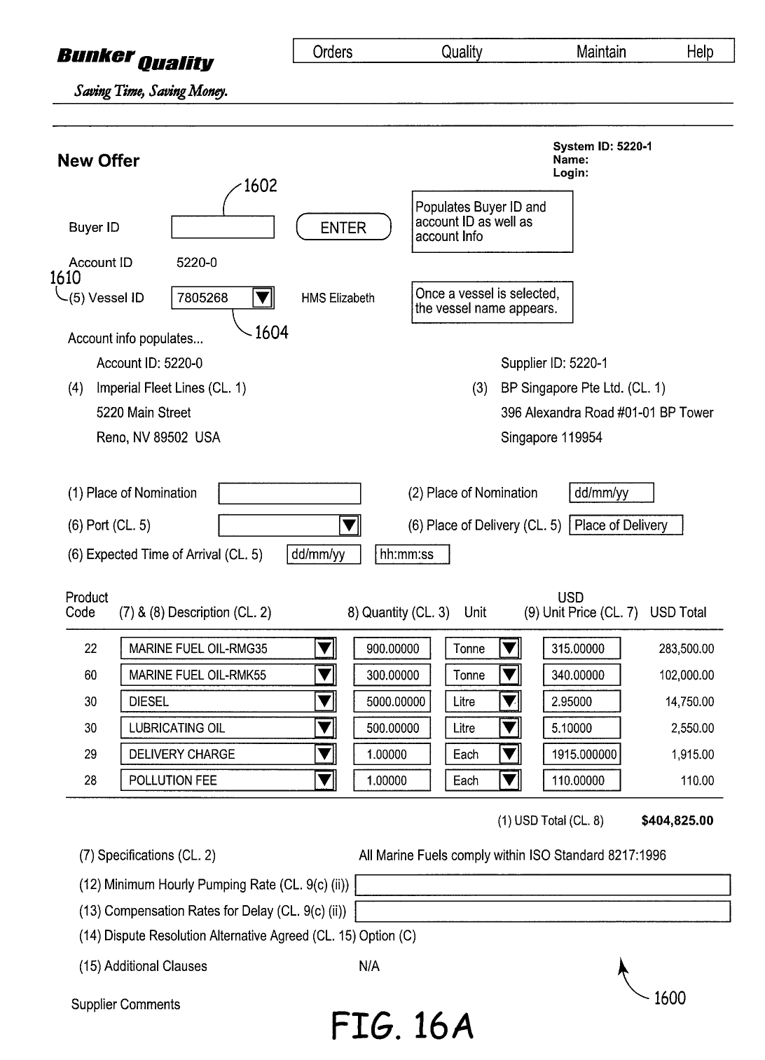

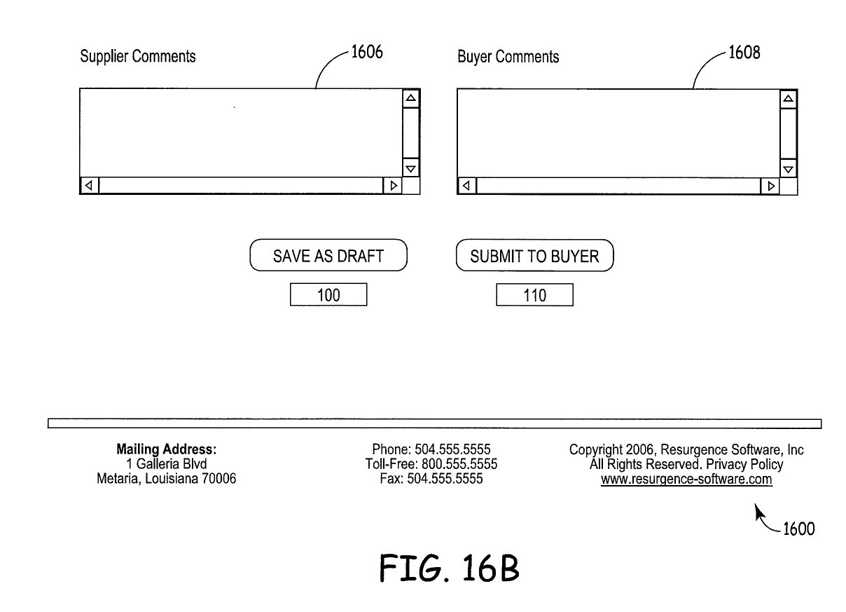

As described above, the buyer 14 and merchant 12, or agents for the buyer or merchant, may negotiate the terms of an agreement. Examples of the agreement process are provided below as way of illustration. In one embodiment, the supplier uses a dashboard 22 that displays a new offer screen 1600. FIGS. 16A and 16B show one example of a supplier new offer screen 1600. The new offer screen 1600 contains offer details 1612 that describe the parties of the agreement and can be edited and populated to include the terms of the agreement. The new offer screen 1600 contains a buyer ID field 1602 that the user can enter a buyer ID into and the dashboard 22 populates the new offer screen 1600 with stored information regarding that particular buyer. In another embodiment, the new offer screen 1600 has a vessel ID field that is either an editable field or a drop-down box where the user can either type in the vessel ID number or select from an assortment of vessels. Some of the editable offer details 1612 listed on the new offer screen 1600 include but are not limited to place of nomination, date of nomination, port, place of delivery, expected time of arrival, product code, product description, product quantity, product unit measure, product unit price, total price of the product, specifications, minimum hourly pumping rate, compensation rates for delay, dispute resolution alternative agreed, and any additional clauses. In one embodiment, the offer details 1612 generally mirror terms of a standard Baltic and International Maritime Council (BIMCO) bunker contract. For example, fields of the offer details 1612 such as vessel ID 1610 reference a standard BIMCO contract through the use of parentheticals shown here as “(5)” that corresponds to item 5 of a current BIMCO contract. New offer screen 1600 may also include a supplier comment field 1606 and/or a buyer comment field 1608 that allows the supplier and buyer to add additional comments as part of the agreement process. After the supplier has filled out the new offer screen 1600, the supplier can submit the offer to the buyer or save the offer as a draft.

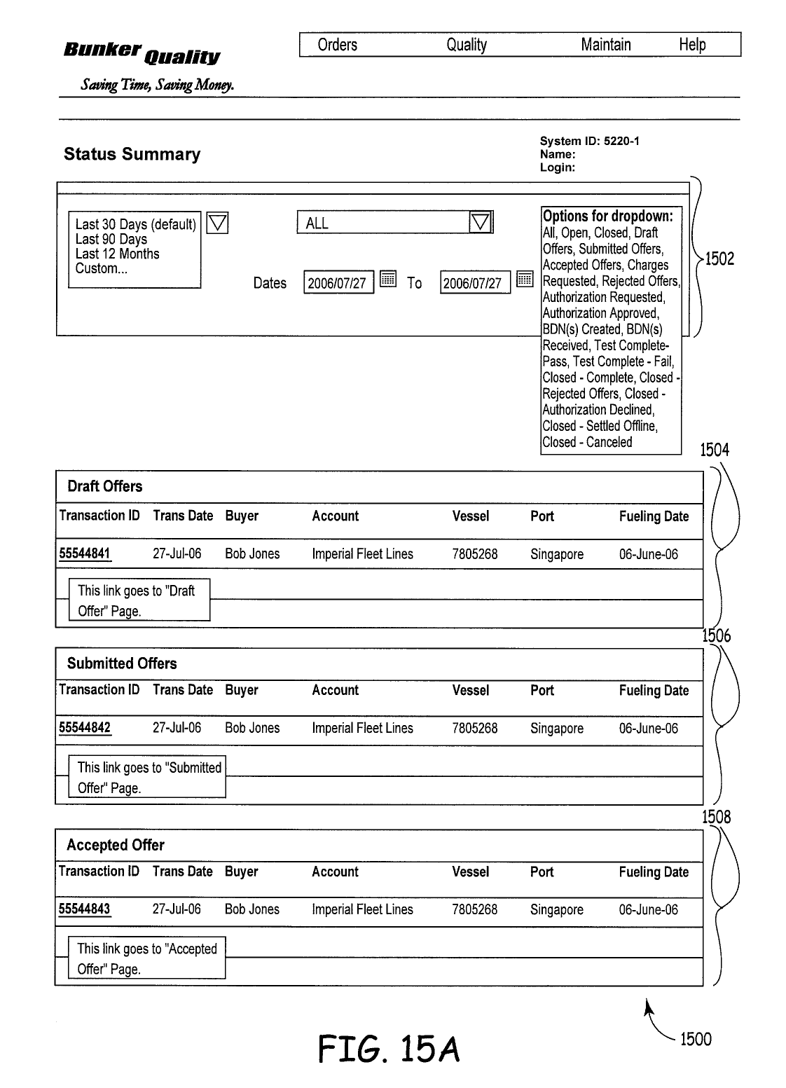

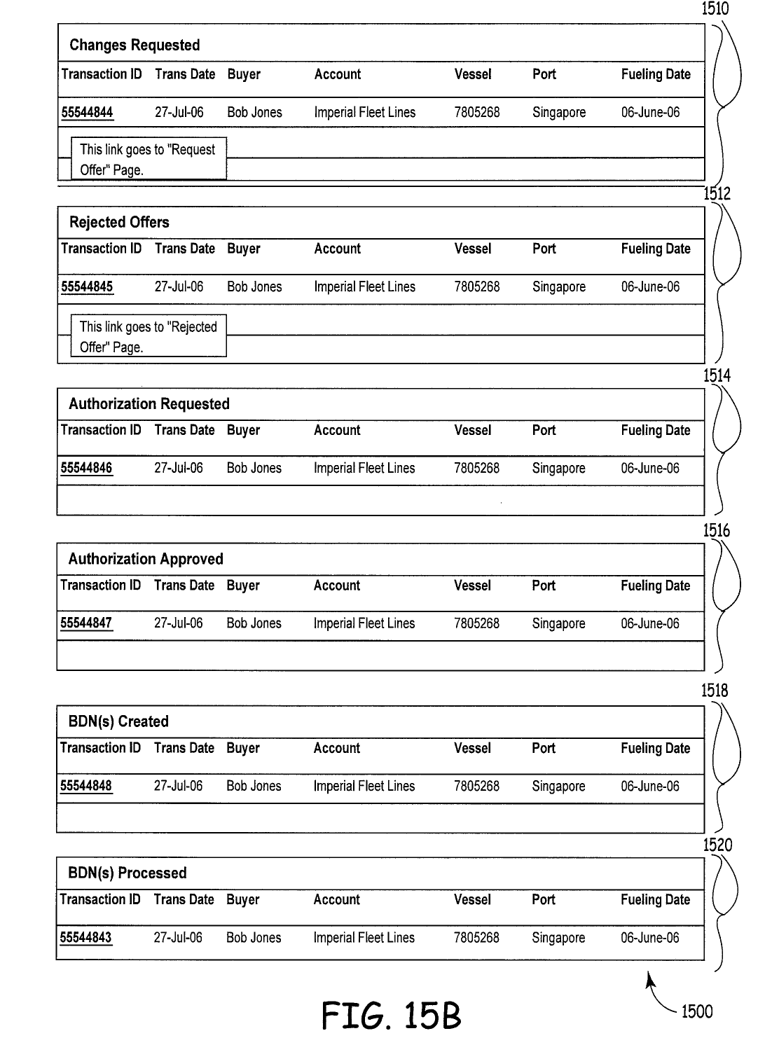

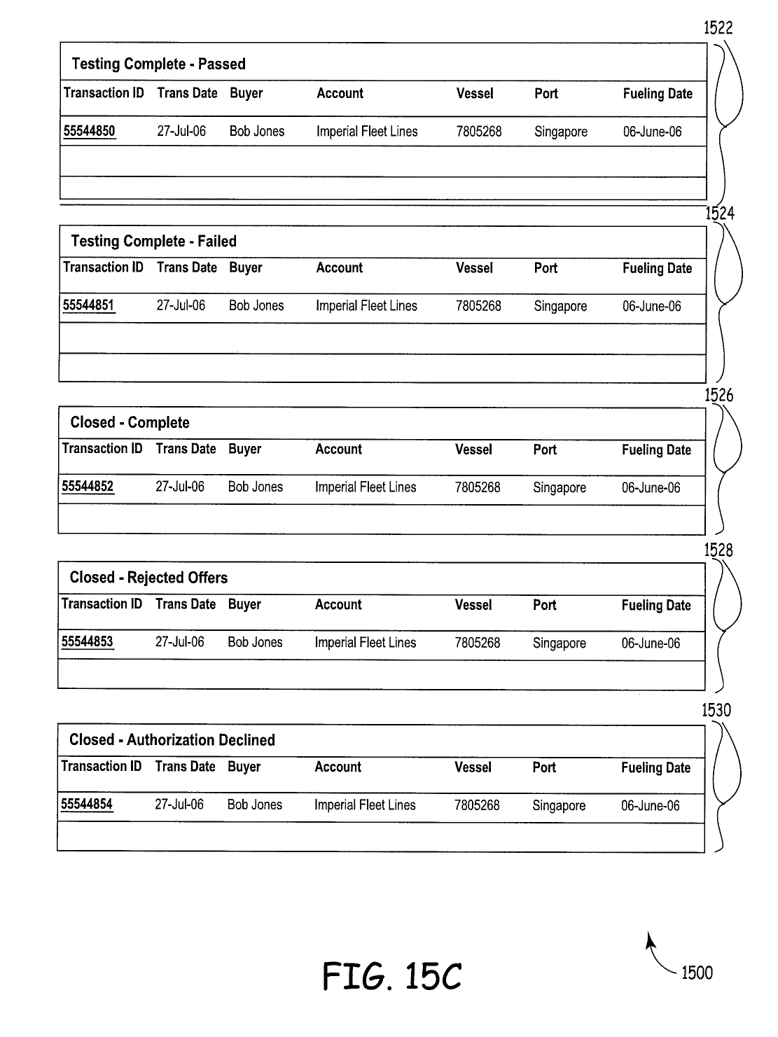

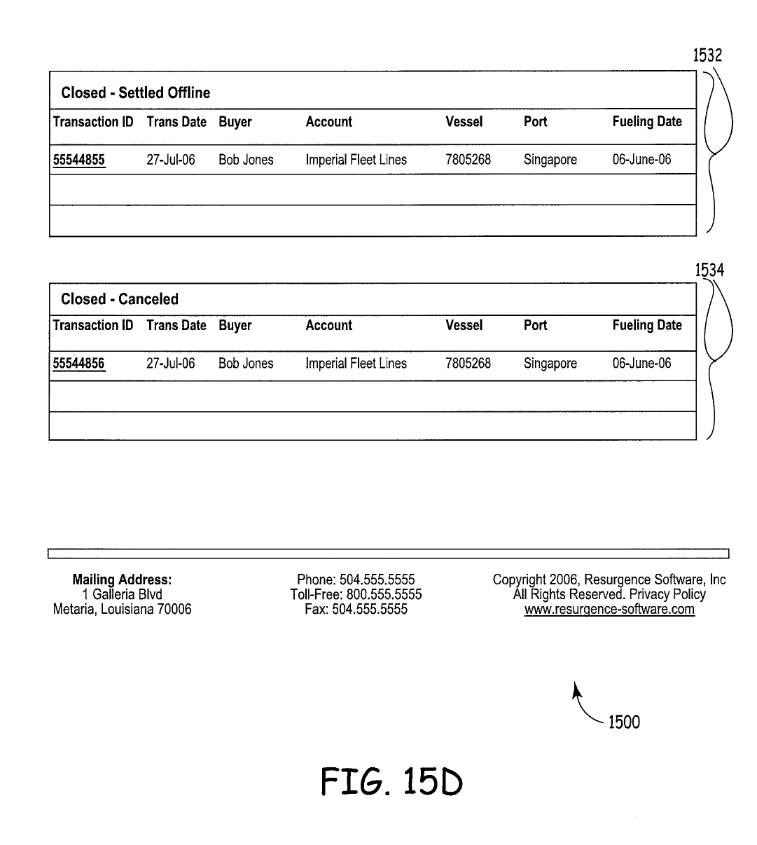

Upon selection by a supplier-user, the dashboard 22 may display a supplier status summary screen 1500. FIGS. 15A, 15B, 15C and 15D show one example of a supplier status summary screen 1500, which may display a summary of all data relating to the supplier. The supplier status summary screen 1500 may include a filter field 1502 which may include an editable field or a drop-down box allowing the user to filter the data based on activity over a period of time. For example, the user could select activity for the last 30 days, the last 90 days, the last 12 months, or any time that the user desires. Likewise, the user can select a specific date in which to view activity. The filter field 1502 may also include an editable field or a drop-down box allowing the user to filter data based on type of activity they wish to view. For example, the user could select to see all activity, open matters, closed matters, draft offers, submitted offers, accepted offers, changes requested, rejected offers, authorization requested, authorization approved, bunker delivery notes created, bunker delivery notes received, test complete pass, test complete fail, closed complete, closed rejected offers, closed authorization declined, closed settled offline, and closed cancelled.

In this embodiment, several data fields are shown, such as a draft offer data field 1504, a submitted offer data field 1506, an accepted offer field 1508, a changes requested data field 1510, a rejected offers data field 1512, an authorization requested data field 1514, an authorization approved data field 1516, a bunker delivery note created data field 1518, a bunker delivery note processed data field 1520, a testing complete passed data field 1522, a testing complete failed data field 1524, a closed complete data field 1526, a closed rejected offers data field 1528, a close authorization declined data field 1530, a closed settled offline data field 1532 and a closed cancelled data field 1534. Each data field has a transaction ID associated with it allowing the data to be identified and tracked. In some embodiments, the data can be accessed by clicking on the transaction ID which is in the form of a hyperlink. The data fields can also list relevant information including but not limited to the transaction date, the name of the buyer, the name of the account, the vessel number, the port name, and the fueling date.

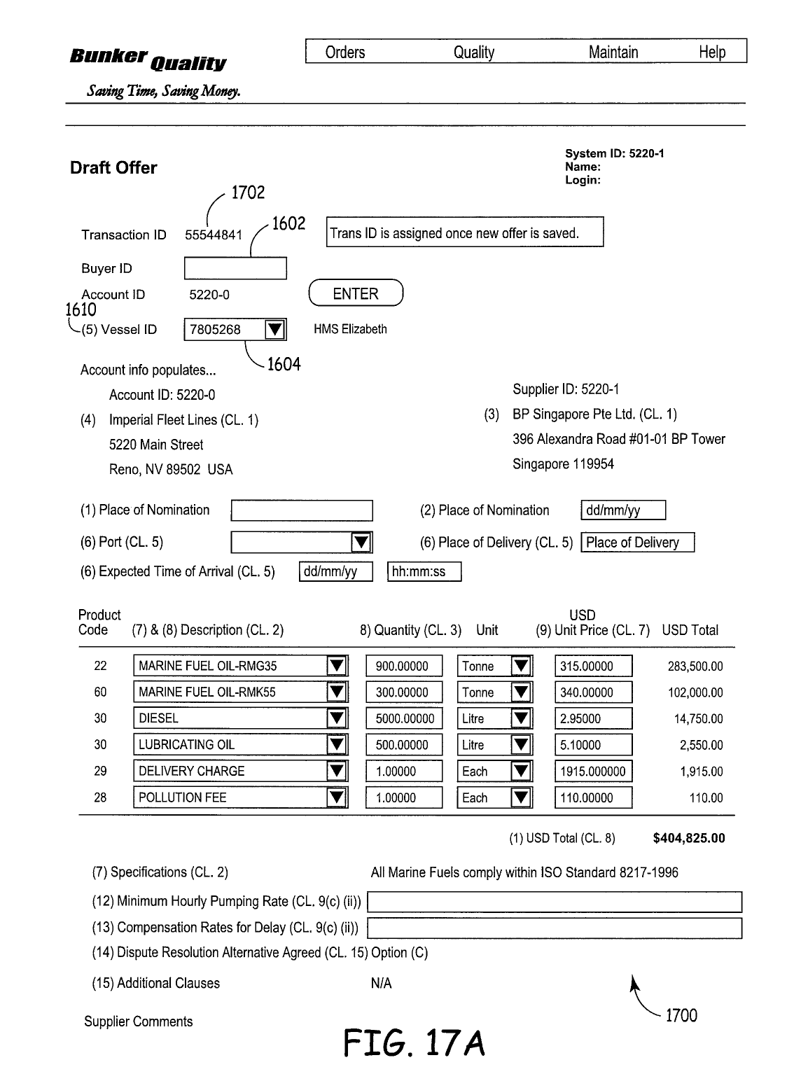

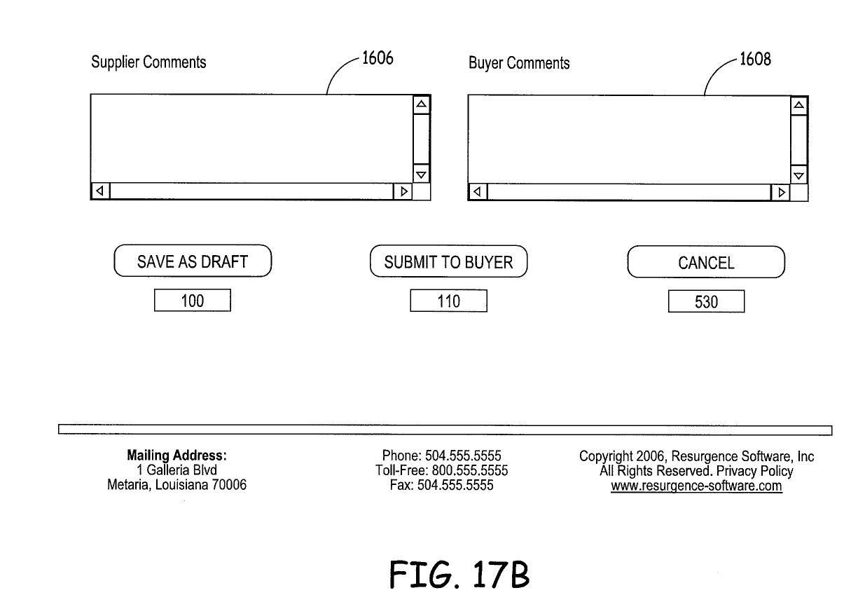

If a new offer was saved as described above with respect to FIGS. 16A and 16B, a draft offer screen 1700 may be created. FIGS. 17A and 17B show one example of a supplier draft offer screen 1700. The draft offer screen may be generally the same as the saved new offer screen 1600 with the addition of a transaction ID field 1702 that was assigned when the new offer screen 1600 was saved. The draft offer screen 1700 allows a user to edit the offer and is accessible by clicking on the hyperlinked transaction ID number located in the draft offer data field 1504 of the supplier status summary screen 1500.

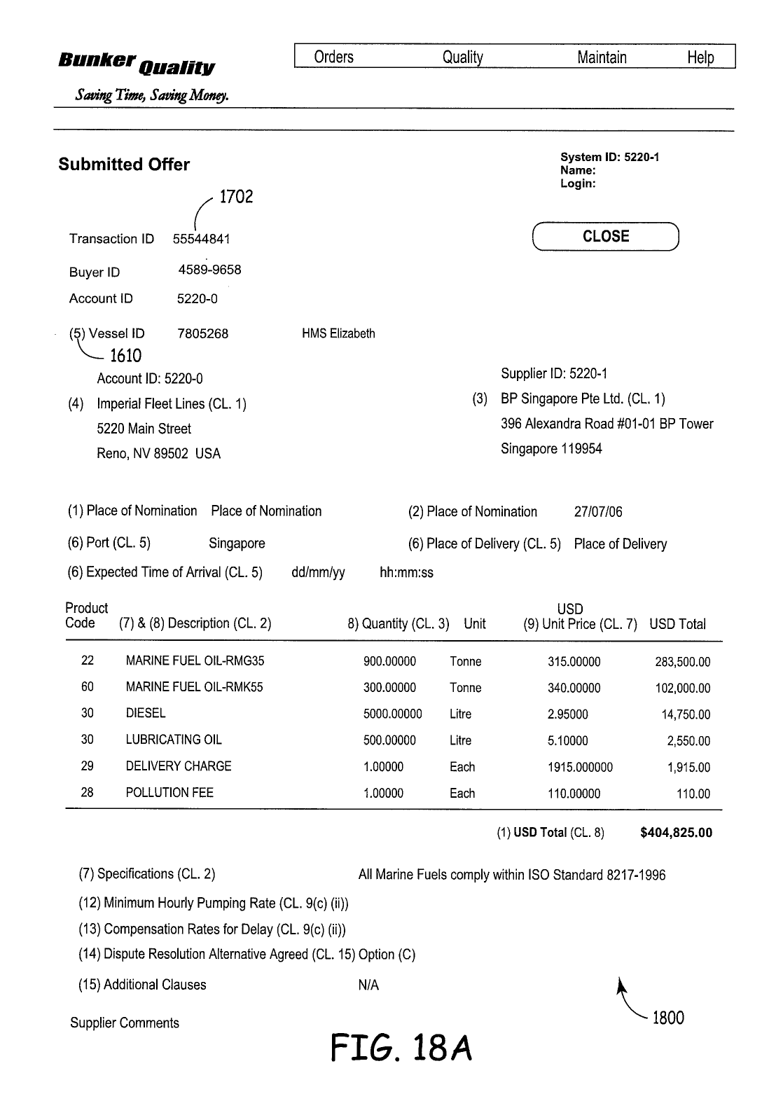

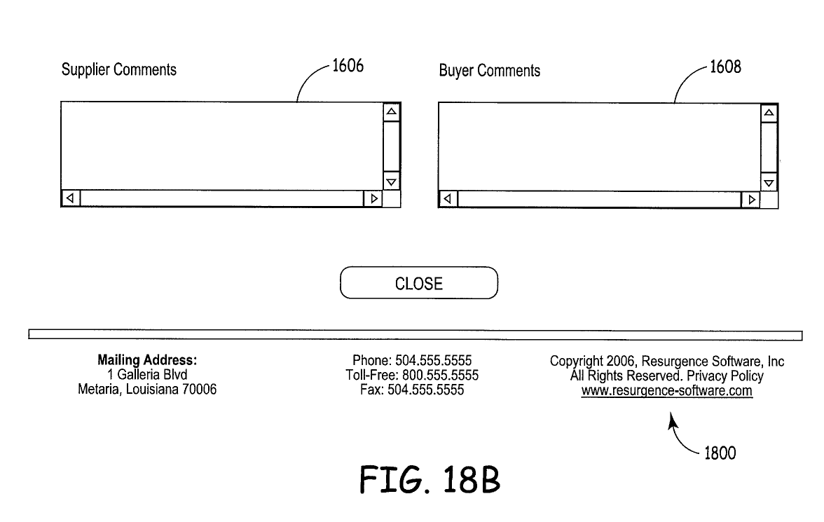

If a new offer was submitted as described above with respect to FIGS. 16A and 16B, a submitted offer screen 1800 may be created. FIGS. 18A and 18B show one example of a supplier submitted offer screen 1800. The submitted offer screen is generally the same as the new offer screen 1600 with the addition of a transaction ID field 1702 that was assigned when the new offer screen 1600 was submitted. The submitted offer screen 1700 may no longer editable at this point and is accessible by clicking on the hyperlinked transaction ID number located in the submitted offer data field 1506 of the supplier status summary screen 1500.

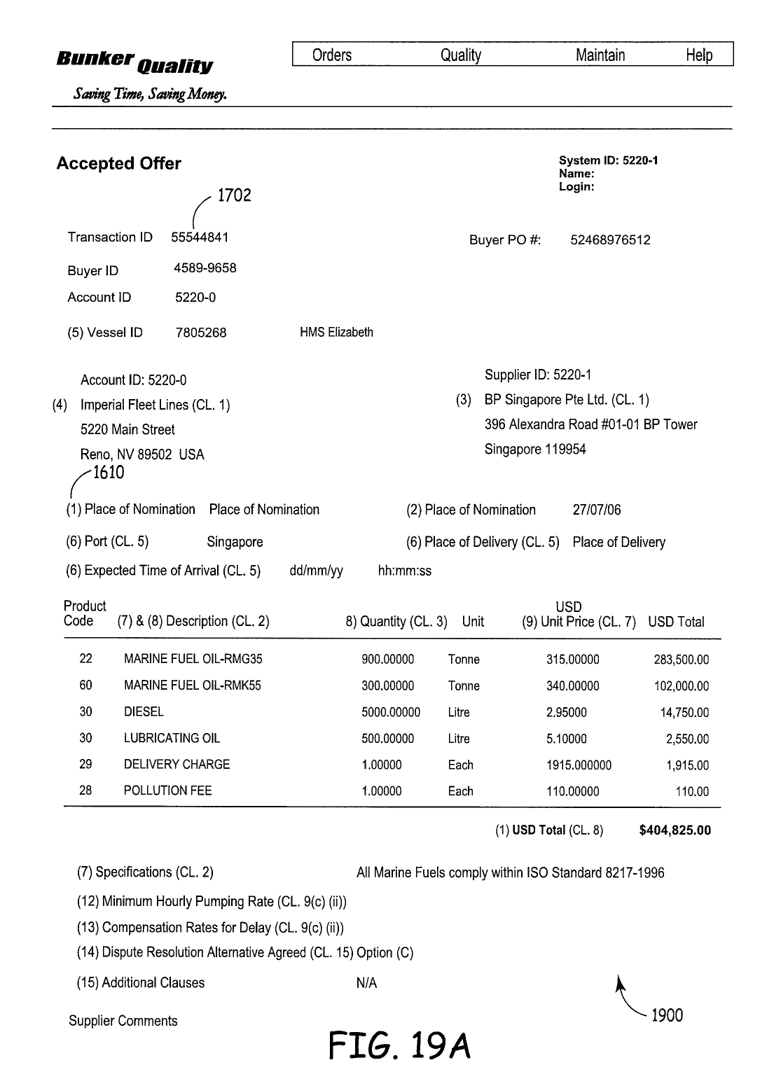

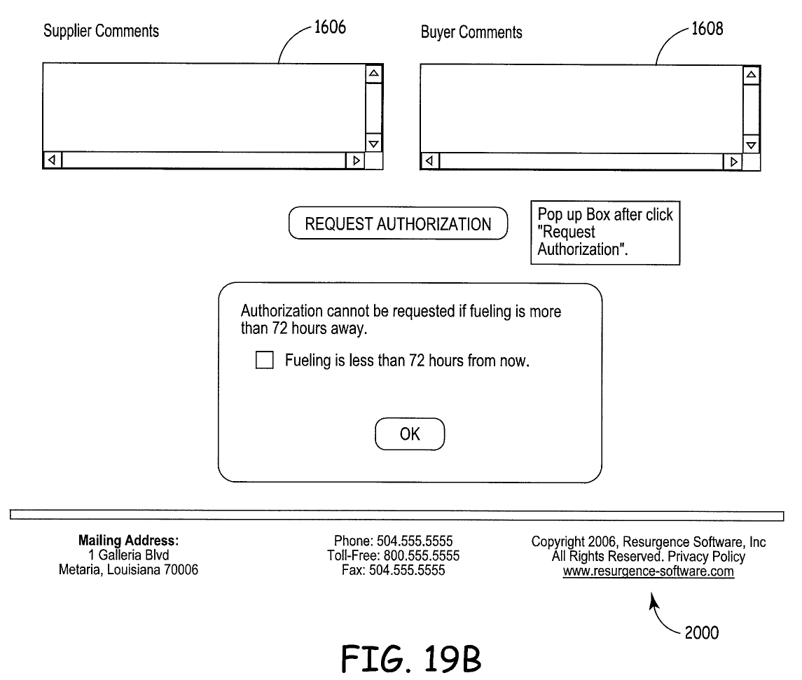

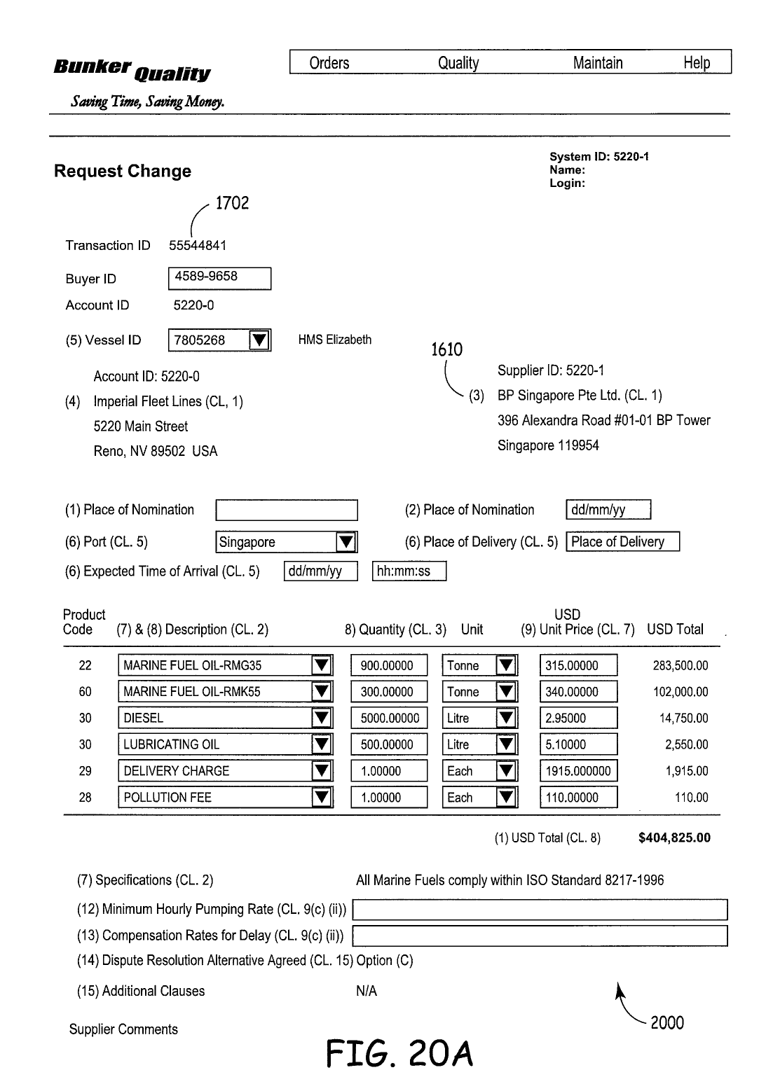

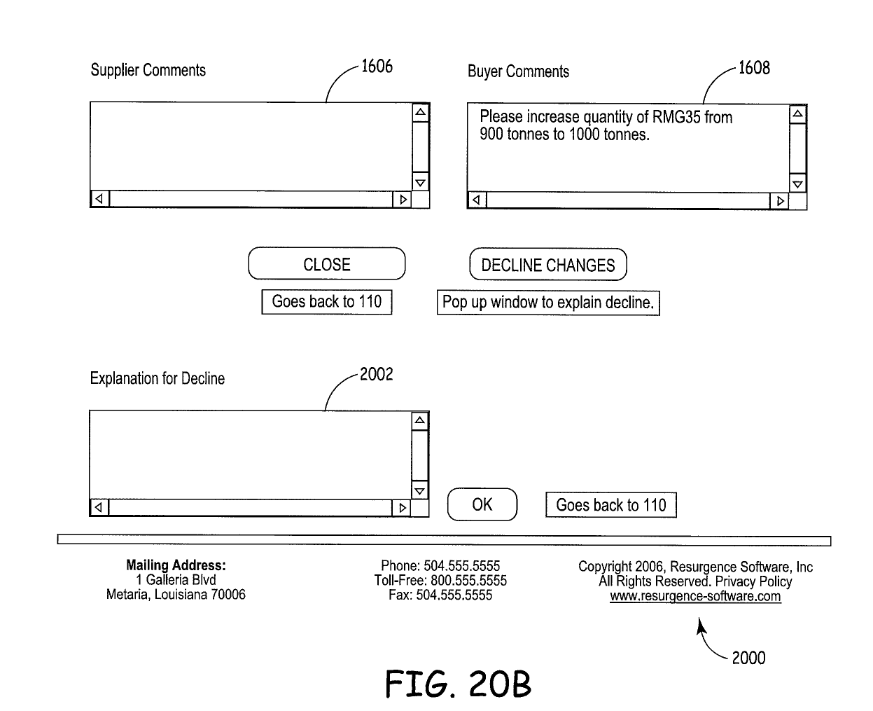

A submitted offer such as the one shown in submitted offer screen 1800 can be accepted, declined, changed, etc. If the offer is accepted, an accepted offer screen 1900 may be created in dashboard 22. FIGS. 19A and 19B show one example of an accepted offer screen 1900. The accepted offer screen 1900 allows a user to request authorization as will be discussed in greater detail below. The accepted offer screen 1900 may be accessible by clicking on the hyperlinked transaction ID number located in the accepted offer data field 1508 of the supplier status summary screen 1500. If a user decides to make changes to the offer, a supplier request change screen 2000 may be created in dashboard 22. FIGS. 20A and 20B show one example of a supplier request change screen 2000. The request change screen 2000 allows the user to edit the offer details 1612. If the user does not want to make changes, the user can provide an explanation of why the changes are not desired in a decline field 2002, and then hit decline changes. If the user has made changes, the user can resubmit the offer. The request change screen 2000 is accessible by clicking on the hyperlinked transaction ID number located in the changes requested data field 1510 of the supplier status summary screen 1500. If the offer is rejected, a rejected offer screen may be created and is accessible by clicking on the hyperlinked transaction ID number located in the rejected offers data field 1512 of the supplier status summary screen 1500.

Returning to FIGS. 3A and 3B, at step 206, the selected merchant 12 may create a bunker order to reflect the agreed-upon transaction. In one embodiment, the merchant 12 may create an electronic transaction record in the dashboard system 22, including the payment servicer account number received from the buyer 14, and the bunker order may be transmitted electronically to the buyer 14 through the dashboard 22. The payment servicer account number may be a number from the buyer's customized transaction card, a credit card number of the buyer, or other suitable payment account information for receiving payment from the payment servicer 16. As described, the merchant 12 may be pre-registered with the payment servicer 16 to receive payments from the servicer via the transaction processing system 40 using the buyer's 14 payment servicer account number.

At step 208, a purchase order corresponding to the agreed-upon transaction may be created, such as in the system of the buyer 14. In one embodiment, the buyer creates the purchase order in an accounting system that is in electronic communication with the transaction processing system. Next, at step 210, the buyer 12 interfaces with the dashboard 22 to add the purchase order to the bunker order created by the merchant 12, and to accept the proposed bunker order. The dashboard 22 electronically records the buyer's acceptance of the bunker order.

Next, payment pre-authorization may be initiated. At a predetermined time prior to the scheduled fueling, the merchant 12 may contact the payment servicer 16 to obtain pre-authorization, as in step 212. In one embodiment, the merchant 12 may contact the payment servicer 16 no earlier than 48 hours prior to the scheduled fueling. In one embodiment, the merchant 12 may contact the payment servicer 16 no earlier than 24 hours prior to the scheduled fueling. Other lengths of time may be suitable for determining the pre-authorization period, and the period may be set by the payment servicer 16 or other entities in the process. The merchant 12 may contact the payment servicer 16 by telephone, electronically through the dashboard 22, or through any other suitable means.

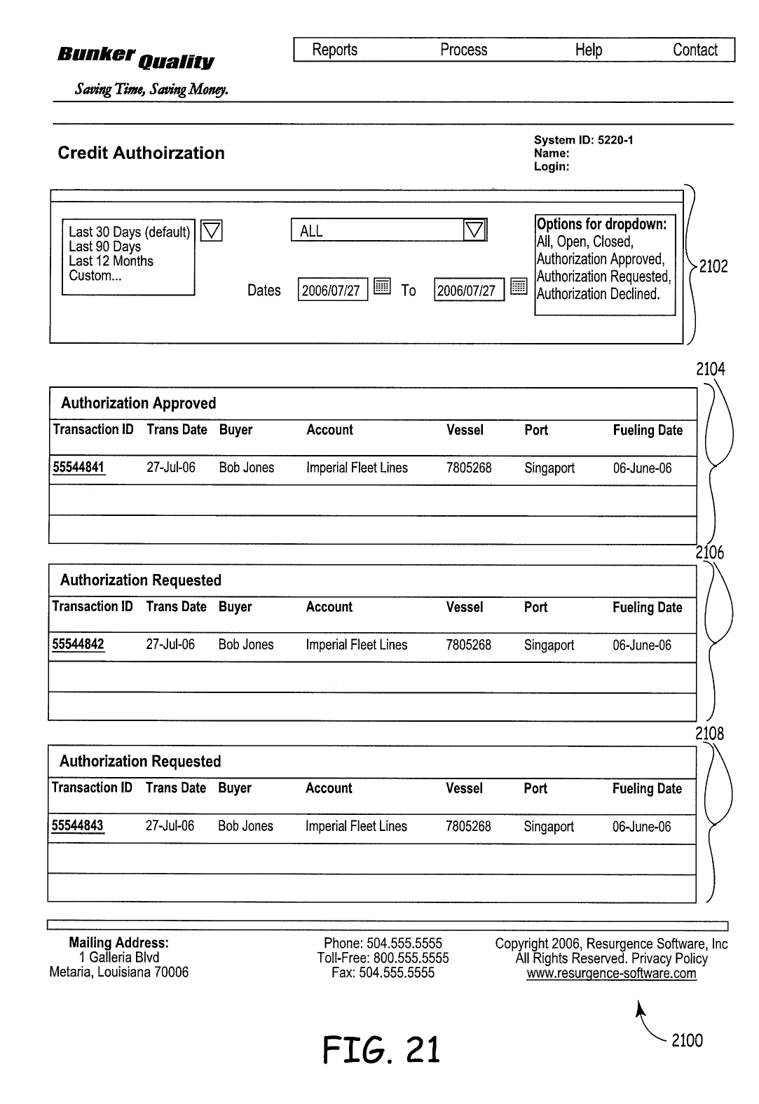

At step 214, the requested pre-authorization may be authorized or denied by the payment servicer 16, or the payment servicer 16 may seek additional information. The decision whether to pre-authorize the request may be based upon a number of factors, including, without limitation, the purchase order created by the buyer 12, the bunker order in the dashboard 22, the status and terms of the payment servicer's 16 merchant agreement 32 with the merchant 12 and account agreement 34 with the buyer 14, etc. Successful pre-authorization does not transfer payment to the merchant 12, but rather pre-authorization verifies that the purchase order and the bunker order conform to the merchant agreement 32, the account agreement 34, and other factors determined by the payment servicer 16. An illustration of a credit authorization screen 2100 in the dashboard 22 is shown in FIG. 21. Credit authorization screen 2100 may include a filter field 2102 which may include an editable field or a drop-down box allowing the user to filter the data based on activity over a period of time. For example, the user could select activity for the last 30 days, the last 90 days, the last 12 months or any time that the user desires. Likewise, the user can select a specific date in which to view activity. The filter field 2102 may also include an editable field or a drop-down box allowing the user to filter data based on type of activity they wish to view. For example, the user could select to see all activity, open matters, closed matters, authorization approved, authorization requested, and authorization declined. In this embodiment, several data fields are shown such as an authorization approved data field 2104, an authorization requested data field 2106 and an authorization declined data field 2108. Each data field has a transaction ID associated with it allowing the data to be identified and tracked. In some embodiments, the data can be accessed by clicking on the transaction ID which is in the form of a hyperlink. The data fields can also list relevant information including but not limited to the transaction date, the name of the buyer, the name of the account, the vessel number, the port name, and the fueling date.

Returning to FIGS. 3A and 3B, if the pre-authorization request is denied, step 216, the payment servicer 16 may contact the buyer 14 to attempt to resolve any correctable impediments to the bunker order. If the denied pre-authorization request cannot be resolved, the payment servicer 16 notifies the merchant 12 and the buyer 14, step 218. At step 220, if the pre-authorization request is approved, the payment servicer 16 notifies the merchant 12 and the buyer 14. In one embodiment, the payment servicer 16 notifies the merchant 12 and the buyer 14 of the successful pre-authorization request via e-mail. In other embodiments, the payment servicer 16 notifies the merchant the buyer via the dashboard system 22 or other suitable means. The payment servicer 16 records the successful pre-authorization request in the dashboard system 22.

At step 222, the fueling described in the bunker order is performed and a fuel test sample is taken. In one embodiment, the test sample is acquired by the merchant 12 or an agent of the merchant. In another embodiment, the test sample is acquired by the buyer 14 or an agent of the buyer. The test sample is acquired with propriety and in a manner that sufficiently satisfies both the buyer and the vendor that the sample is representative of the bunker delivered to the buyer 12. The sampling requirements and sampling procedures, the details and requirements of the test, location of the sampling equipment, and other aspects of the manner in which the test sample is obtained and tested may be standardized or they may be agreed upon by the buyer and the merchant during the negotiation of the bunker order. Other readings may also be taken at the time of fueling to ensure adherence to the quality and quantity specified in the bunker order, such as tank measurement, tank gauging, bulk density, cargo temperature, etc.

At the time the fuel is supplied, a bunker deliver note (BDN) is created by the merchant 12, step 224. The BDN is used to record the specifications and quantities of the bunkers delivered to a vessel. In one embodiment, the merchant may create the BDN electronically by interacting with the dashboard 22 or other electronic interface. In this embodiment, the BDN may be electronically associated with the pre-authorization approved for the transaction. In another embodiment, the merchant creates the BDN physically on paper or through other suitable means. The buyer and the merchant may sign or authorize, electronically or physically, the BDN, step 226. The BDN may be signed or authorized by other interested parties, as may be necessary.

At step 228, buyer 12 notes satisfaction on the BDN and sends the BDN and the sample obtained at the time of refueling to the testing facility 18. The BDN may be provided to the testing facility 18 by facsimile or in an electronic format via the dashboard 22 or through other electronic means. Alternatively, the BDN may be provided to testing facility 18 by postal mail or other physical delivery service. Upon receipt of the delivery note, or a reproduction of the delivery note, step 230, the testing facility 18 may scan the BDN and add the note data to a file maintained for the bunker transaction. In one embodiment, the testing facility 18 maintains an electronic file for the bunker transaction, and upon receipt of the delivery note, an electronic version of the BDN may be uploaded into the electronic file for the bunker transaction.

At step 232, the testing facility performs the pre-determined test on the fuel test sample associated with the BDN. The testing facility 18 may include an internal laboratory for performing the testing, or the fuel test sample may be transferred to a remote testing laboratory. The testing facility 18 either may be mutually agreeable to both buyer 14 and merchant 12, it may be selected by the payment servicer 40 or other entity, or it may be selected by either the buyer 14 or the merchant 12. In some embodiments, the buyer 14 and merchant 12 may use their own testing facility 18, either in addition to or in lieu of the testing facility 18 used by both buyer 14 and merchant 12.

Upon completion of the test, the fuel test results are matched to the BDN and the original bunker order. The testing facility 18 may enter the test results into the dashboard 22. The testing facility 18 may also transmit the test results directly to the merchant 12 and the buyer 14. The fuel sampling methods, point of sampling, and tests may be included in the merchant agreement 32 and the account agreement 34 and may be based on ISO standards.

In other embodiments, any desired testing or evaluation may be performed for any desired product or service in any desired industry. For example, in the construction industry, testing or inspections may be performed on the quality of materials or finished product, such as to ensure compliance with contractual specification, or with local or industry standards, codes, or regulations, etc. In still other embodiments, the testing may be done with respect to any product or service provided in the marine industry. In other embodiments, the system and method of the present invention may be used in any industry, including in the marine industry, whether or not quality assurance or testing aspects are involved.

In addition to quality testing, the testing facility 18, or other entity, may perform random quantity surveys to ensure that fuel deliveries are at the stated volume. The testing facility 18, or other entity, may also certify a merchant's internal management systems and processes, thereby proactively promoting fuel quality. Such prophylactic or proactive testing may include quality checks up through a merchant's fuel supply chain, through wholesalers and refineries. Failure of a fuel quantity survey or internal management system and process review may subsequently be treated the same as a failure of a fuel quality survey.

The testing facility 18 analyzes the test results and determines whether the fuel test sample passed the test based on predetermined criteria, step 234. If the fuel test sample passes the test, the testing facility may assemble the relevant items in the file maintained for the bunker transaction, which may include the bunker order contract, the test results, the BDN, other desired information, etc., step 236.

If the fuel test sample fails the test, the testing facility 18 notifies the merchant 12 and the buyer 14 of the failed test results, and the merchant and the buyer may enter into prearranged dispute resolution proceedings, step 238. The specific dispute resolution process is stipulated in the various agreements entered into by the merchant and the buyer. During the proceedings, the parties may attempt to remedy the failed test of the delivered fuel and agree upon a course of action, such as a payment to the merchant that is reduced from the originally agreed-upon payment. Other remedies may be suitable for the parties and may be introduced to the dispute resolution proceedings. The dispute resolution proceedings may be capped at a predetermined period. In one embodiment, the dispute resolution must be completed within five days of receiving notification of the failure. If the dispute resolution is successfully resolved, the parties send a notification to the testing facility, step 240, the merchant 12 updates the transaction with the revised terms in the dashboard 22, and the buyer 14 indicates acceptance of the revised terms in the dashboard 22. If an agreement between the buyer 14 and the seller 12 cannot be reached then a contractual mediation process, or other prearranged process, may be initiated. At the end of the mediation process, a de facto agreement is reached, which is then treated as if an agreement had been reached during the dispute resolution.

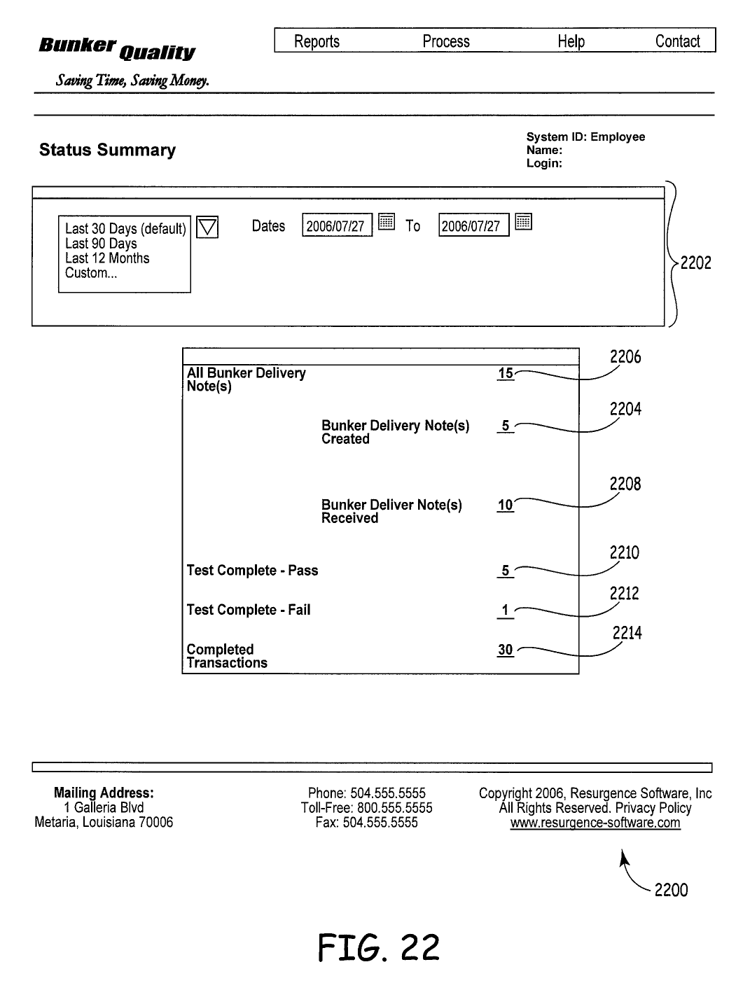

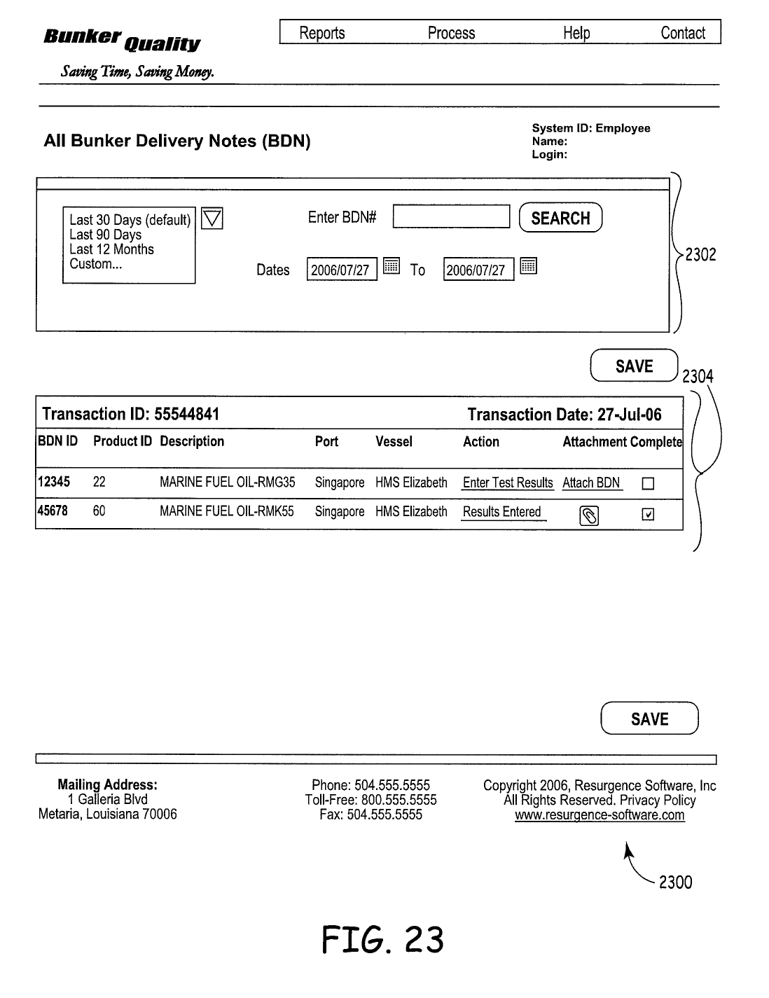

An illustration of the dashboard 22 for the testing facility 18 is shown in FIGS. 22-26. A testing status summary screen 2200 is shown in FIG. 22. The testing status summary screen 2200 may include a filter field 2202 which may include an editable field or a drop-down box allowing the user to filter the data based on activity over a period of time. For example, the user could select activity for the last 30 days, the last 90 days, the last 12 months or any time that the user desires. Likewise, the user can select a specific date in which to view activity. Based on the time period selected, an all bunker delivery notes field 2206, a bunker delivery notes created field 2204, a bunker delivery notes received field 2208, a test complete pass field 2210, a test complete fail field 2212 and a completed transactions field 2214 will be populated with the number of items that fall under the above listed categories during the selected time period. Each of the fields have hyperlinks directing a user to view each of the items under that particular field when clicked. For example, the all bunker delivery notes field 2206 when clicked, directs the user to the all bunker delivery notes screen 2300 shown in FIG. 23.

The all bunker delivery notes screen 2300 may include a filter field 2302 which may include an editable field or a drop-down box allowing the user to filter the data based on activity over a period of time. For example, the user could select activity for the last 30 days, the last 90 days, the last 12 months or any time that the user desires. Likewise, the user can select a specific date in which to view activity, or a particular bunker delivery note number. Based on the user's selection in the filter field 2302, a listing of bunker delivery notes are populated in the all bunker field 2304. The all bunker field 2304 may show the bunker delivery note ID number, the product ID number, a description of the product, the port name, the vessel name, an action to be performed, an attachment option, and whether or not it is complete.

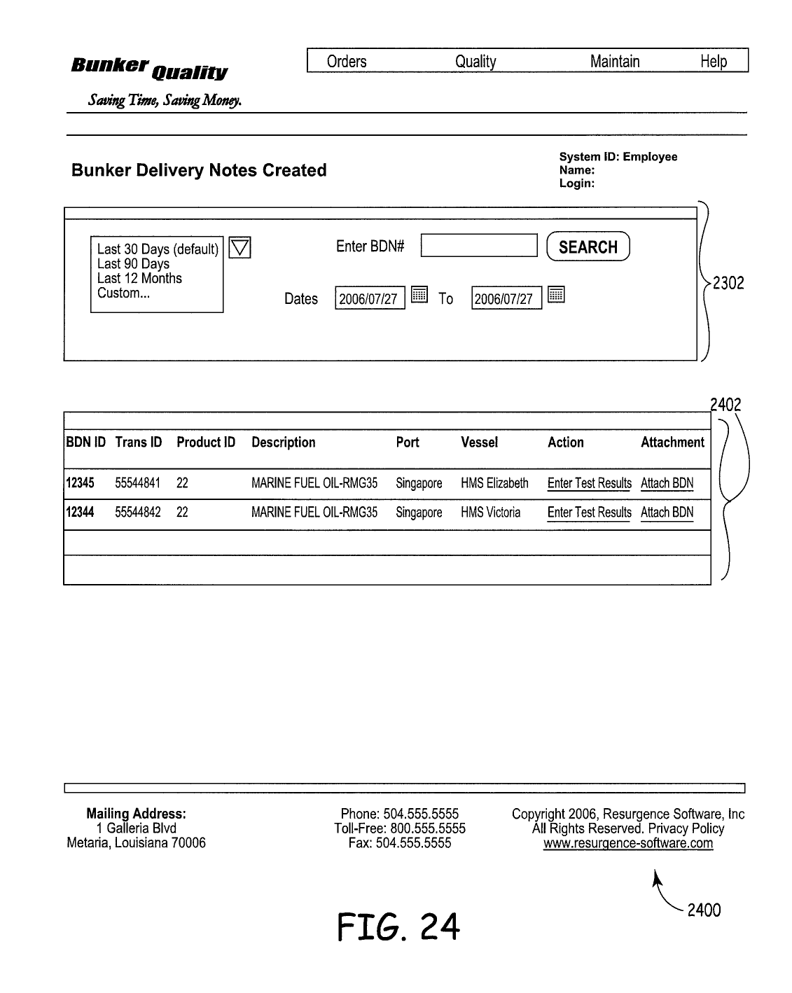

FIG. 24 illustrates a bunker delivery notes created screen 2400. The bunker delivery notes created screen 2400 may be accessible by clicking on the hyperlinked bunker delivery notes created field 2204 on the testing status summary screen 2200. The bunker delivery notes created screen 2400 may include a filter field 2302 as described above. Based on the user's selection in the filter field 2302, a listing of bunker delivery notes created are populated in the created bunker field 2402. The created bunker field 2402 may show the bunker delivery note ID number, the transaction ID number, the product ID number, a description of the product, the port name, the vessel name, an action to be performed, and an attachment option.

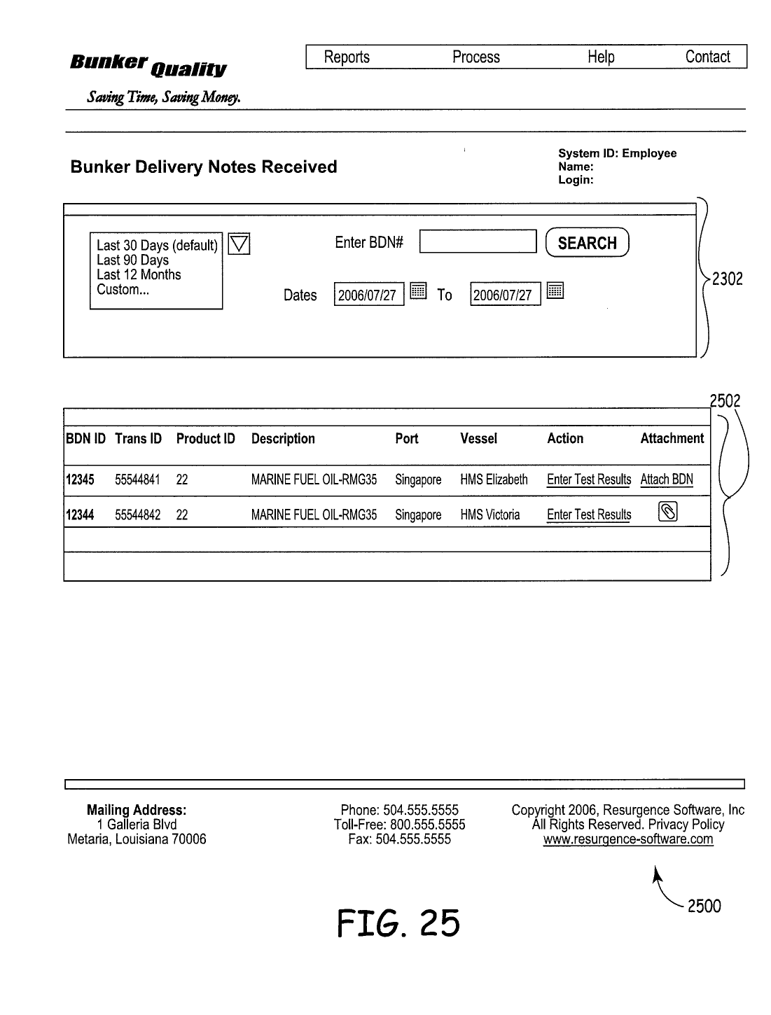

FIG. 25 illustrates a bunker delivery notes received screen 2500. The bunker delivery notes received screen 2500 is accessible by clicking on the hyperlinked bunker delivery notes received field 2208 on the testing status summary screen 2200. The bunker delivery notes received screen 2500 may include a filter field 2302 as described above. Based on the user's selection in the filter field 2302, a listing of bunker delivery notes created may be populated in the received bunker field 2502. The received bunker field 2502 may show the bunker delivery note ID number, the transaction ID number, the product ID number, a description of the product, the port name, the vessel name, an action to be performed, and an attachment option.

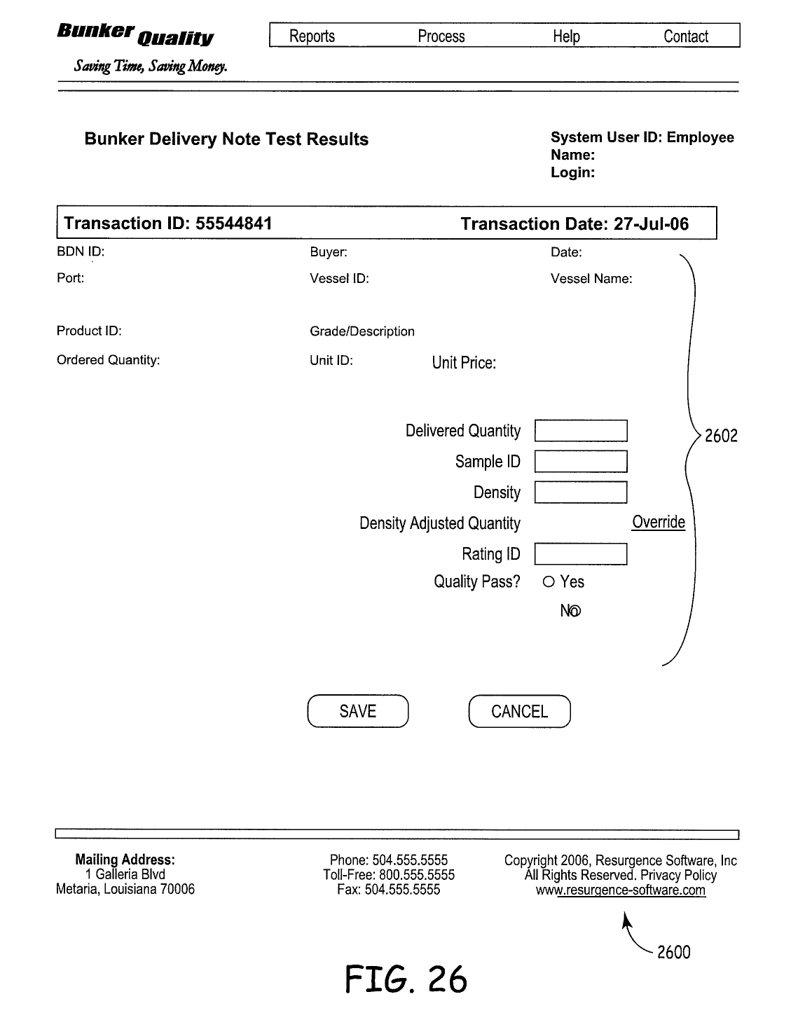

FIG. 26 illustrates a bunker delivery note test results screen 2600. The bunker delivery note test results screen 2600 has a test results field 2602 that may be editable by a user. For a particular transaction ID, the user can fill in relevant data including but not limited to the bunker delivery note ID, the port name, the product ID number, the ordered quantity, the buyer name, the vessel ID, the grade/description of the product, the unit ID, the date, the vessel name, and the unit price. In one embodiment, these fields are automatically populated using the data accumulated during the agreement process and the offer screens described above. The test results field 2602 further may include editable fields such as the delivered quantity, the sample ID, the density, the density adjusted quantity (which can be activated or deactivated), the rating ID, and whether the quality passes the test or fails the test.

Returning to FIGS. 3A and 3B, after a positive test result or a successful dispute resolution or mediation, the density adjust may be performed, step 242. In other embodiments, the timing of the density adjust and any testing are independent, or done generally contemporaneously or in any desired manner or sequence. Because the overall volume of fuel and the fuel's bulk density may vary based on some unknown amount of entrained air, in some embodiments, it may be desirable to allow sufficient time for the air to bubble out of the fuel, and the fuel level to adjust accordingly, before making a determination as to how much fuel actually was provided in any given transaction. Payment then may be made based on the density adjusted amount of fuel.

The testing facility 18 may complete the testing portion of the transaction, and provide the test results, the BDN data, and other relevant information pertaining to the fuel test sample and corresponding bunker transaction, to the payment servicer 16, step 244. In one embodiment, the testing facility 18 may post the passing test results and other relevant information to the dashboard 22, which is subsequently accessed by the payment servicer 16. The testing facility 18 may assign a unique test number to the fuel test sample that serves as a purchase order number that controls payment of the bunker transaction.

In one embodiment, the buyer 14 and the merchant 12 have agreements with the payment servicer 16, whereby the transaction processing system 40 automatically provides payment to the merchant 12 upon receipt of the passing test results. In this embodiment, responsive to the test data from the testing facility 18, the transaction processing system 40 creates a purchase order and a final payment transaction and pays the merchant 12 and charges the buyer's 14 account. For example, upon completion of the transaction by the testing facility, step 244, the payment servicer 16 receives notification of the transaction, step 246. Upon receiving notification of the transaction, a representative of the payment servicer 16 may log in to the dashboard system 22 as a payment-user, step 248, to view the transaction details. If the transaction details are approved by the payment servicer 16, the payment servicer 16 pays the merchant 12 the contract amount for the fuel delivery through a prearranged payment delivery channel, step 250, and the merchant 12 receives the payment, step 252.

In another embodiment, the buyer 14 and the merchant 12 have agreements with the payment servicer 16 whereby the transaction processing system 40 does not automatically provide payment to the merchant, and the buyer and merchant interact with the transaction processing system 40 to achieve the payment. In this embodiment, upon receipt of the passing test results by the buyer 14, a representative of the buyer logs in to the transaction processing system 40, and the buyer-user is prompted to enter information that uniquely identifies the payment transaction. The information may include a purchase order number, the number from a customized transaction card or a credit card, a merchant account number, a payment amount, or other suitable information. The buyer-user enters the information into the transaction processing system 40, and the system receives the information. Responsive to receipt of such information, the transaction processing system 40 creates a purchase order, including a purchase order number. This purchase order number may be matched with the purchase order in the pre-authorized bunker order. The purchase order number may be the same number as the unique test number that was assigned by the testing facility 18 to the fuel test sample. Next, the buyer 14 may communicate through any suitable means to the merchant 12 that the payment transaction is prepared for payment.

Responsive to receiving notification from the buyer 14 that the payment transaction is prepared for payment, a representative of the merchant may log in to the transaction processing system 40 and submits information, such as an invoice, to the system 40, along with any other requested information required by the payment servicer 16. The transaction processing system 40 verifies the information received from the merchant-user and provides an approval code to the merchant-user. Upon successful verification, the transaction processing system 40 initiates the settlement and billing functions. The settlement functions include providing payment to the merchant 12 according to the parameters of the merchant agreement 32 between the merchant 12 and the payment servicer 16. For example, the parties may have entered into to a merchant agreement 32 whereby the transaction processing system 40 pays the merchant 12 via a check, ACH funding, EDI transmissions, a combination of funding methods, or any other suitable payment mechanism.

The billing functions of the transaction processing system 40 include providing billing statements to the buyer 14 according to the parameters of the account agreement 34 between the buyer 14 and the payment servicer 16, steps 254 and 256. The payment servicer 16 may bill the buyer 14 on a predetermined periodic basis through an agreed-upon channel, whereby the payment servicer provides a consolidated periodic bill to the buyer, which may include some or all of the buyer's purchases over a designated period, specific desired information relating to the transactions, summaries of information, etc. The format of the bill may be standardized, variable, specific to certain buyers 14, or provided in any other desired fashion. By the terms of the account agreement 34, the buyer pays the bill, step 258, and the payment servicer 16 receives such payment, step 260. The payment servicer 16 may also provide sales reports on a periodic basis to the merchant 12, step 262, which are received by the merchant, step 264.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method for managing the procurement of goods or services by a buyer, the method comprising:
forming an agreement between a provider and the buyer;
performing at least one of a quality or quantity check on the provider's goods or services; and
providing a payment to the provider for the goods or services based on the actual quality or quantity of the goods or services delivered to the buyer based on the quality or quantity check.

2. The method of claim 1 further comprising reviewing one or more providers' data regarding each provider's goods or services.

3. The method of claim 2, wherein providers' data comprises one of previous quality and previous quantity measures.

4. A method for managing the procurement of goods or services that ensures by third party verification that items purchased meet an agreed quality standard, the method comprising:
identifying suppliers based on objective previous quality and quantity measures that are appropriate for the goods or services being procured;
selecting a supplier based on the objective previous quality and quantity measures;
providing a payment service whereby the payment service enters into agreements with the buyer and the supplier and wherein the payment service creates an agreement between the buyer and the supplier by virtue of the buyer and supplier's respective agreements with the payment service;
ensuring the goods or services supplied to the buyer are to the specified quantity and quality in the agreement between the buyer and the supplier by applying objective tests wherein the objective tests generate actual quality and actual quantity measures;
completing the transaction between the buyer and the supplier if the actual quality and actual quantity measures meet the specifications of the agreement between the buyer and the supplier; and
providing a resolution process if the actual quality and actual quantity measures do not meet the specifications of the agreement between the buyer and the supplier.

5. A method for managing fuel procurement and payment services for marine bunkering transactions, the method comprising:
establishing a bunker order between a fuel merchant and a buyer, said bunker order setting forth an amount of fuel to be supplied to the buyer by the fuel merchant, bunker specifications to be satisfied by the amount of fuel, and a price for the amount of fuel;
delivering said amount of fuel set forth in the bunker order from the fuel merchant to the buyer;
obtaining a fuel test sample from the amount of fuel delivered to the buyer and transmitting said fuel test sample to a bunker surveyor;
testing the fuel test sample, whereby said bunker surveyor measures at least one bunker factor of the fuel test sample and prepares test results indicating whether said at least one bunker factor of the fuel test sample satisfies said bunker specifications;
transmitting said test results from said bunker surveyor to a payment service;
if said test results indicate satisfaction of said bunker specifications, electronically providing a payment from said payment service to said fuel merchant for delivering the amount of fuel in accordance with the bunker order and billing said buyer for said payment; and
if said test results indicate failure to satisfy said bunker specifications, awaiting notification of a successful resolution between said fuel merchant and said buyer prior to electronically providing the payment from said payment service to said fuel merchant and billing said buyer for said payment.

6. The method for managing fuel procurement and payment services of claim 5, wherein the fuel merchant and the payment service, prior to establishment of the bunker order, enter into a merchant agreement setting forth payment terms for the payment from said payment service to said fuel merchant, and setting forth testing terms of the testing performed on said fuel test sample by said bunker surveyor.

7. The method for managing fuel procurement and payment services of claim 5, wherein the buyer and the payment service, prior to establishment of the bunker order, enter into an account agreement setting forth a line of credit to the buyer for funding the payment to the fuel merchant, and setting forth testing terms of the testing performed on said fuel test sample by said bunker surveyor.

8. The method for managing fuel procurement and payment services of claim 5, wherein the payment service extends a line of credit to said buyer prior to establishment of the bunker order, and wherein the step of electronically providing the payment to the fuel merchant includes borrowing against said line of credit.

9. The method for managing fuel procurement and payment services of claim 5, wherein the payment service and the bunker surveyor, prior to establishment of the bunker order, enter into a testing services agreement setting forth procedures for obtaining the fuel test sample and testing the fuel test sample.

10. The method for managing fuel procurement and payment services of claim 5, further comprising the step of performing a fuel quantity survey, whereby the bunker surveyor assesses the amount of fuel delivered to the buyer.

11. The method for managing fuel procurement and payment services of claim 5, wherein said bunker specifications are determined based on standards set by the International Organization for Standardization (ISO).

12. The method for managing fuel procurement and payment services of claim 5, wherein, if said test results indicate failure to satisfy said bunker specifications, said fuel merchant and said buyer commence a predetermined dispute resolution process.

13. The method for managing fuel procurement and payment services of claim 12, wherein, if the successful resolution between said fuel merchant and said buyer includes a reduced price for said amount of fuel, said payment service being notified of said reduced price prior to the payment to the fuel merchant.

14. The method for managing fuel procurement and payment services of claim 12, wherein said payment service provides a transaction processing system adapted to receive electronic indicia of fuel delivery and test results and to electronically provide the payment to said fuel merchant.

15. The method for managing fuel procurement and payment services of claim 5, further comprising the step of requesting preauthorization, prior to delivering said amount of fuel to the buyer, including transmitting a pre-authorization request from said fuel merchant to said payment service, where approval of said pre-authorization request by said payment service is required before the payment service provides the payment to the fuel merchant.

16. The method for managing fuel procurement and payment services of claim 15, wherein said payment service receives said pre-authorization request and approves the said pre-authorization request upon validity verification of the bunker order.

17. The method for managing fuel procurement and payment services of claim 5, further comprising the step of providing a networked computer software application adapted to provide a user interface to the buyer, receive fuel merchant search criteria from the buyer, and display a result list of fuel suppliers matching said search criteria to the buyer, said displayed fuel suppliers being suitable for delivering fuel to the buyer in accordance with the bunker order.

18. A transaction system for managing fuel procurement and payment services for marine bunkering transactions, the system comprising:
a fuel merchant;
a buyer, said fuel merchant and said buyer being in communication to enter into a bunker order for supplying an amount of fuel meeting predefined bunker specifications to the buyer; and
a transaction processing system operatively associated with said fuel supplier and said fuel buyer and adapted to:
receive notification of a fuel delivery to the buyer corresponding to said bunker order;
receive test results from a bunker surveyor, said test results including a measurement of at least one bunker factor of a fuel test sample taken from the amount of fuel supplied at the fuel delivery to the buyer;
if said measurement of said at least one bunker factor satisfies a predetermined criterion defined by said predefined bunker specifications, electronically provide a payment to said fuel merchant for supplying the amount of fuel in accordance with the bunker order and bill said buyer for said payment; and
if said measurement of said at least one bunker factor does not satisfy the predetermined criterion defined by said predefined bunker specifications, await notification of a resolution between said fuel merchant and said buyer prior to electronically providing the payment to said fuel merchant and billing said buyer for said payment.

19. The transaction system of claim 18, wherein said predetermined criterion defined by said predefined bunker specifications is set by the International Organization for Standardization (ISO).

20. The transaction system of claim 18, wherein a merchant agreement sets forth payment terms for the payment from said transaction processing system to said fuel merchant, said merchant agreement further setting forth testing terms of the testing performed on said fuel test sample by said bunker surveyor.

21. The transaction system of claim 18, wherein an account agreement sets forth a line of credit to the buyer for funding the payment to the fuel merchant, said account agreement further setting forth testing terms of the testing performed on said fuel test sample by said bunker surveyor.

22. The transaction system of claim 18, wherein a line of credit is extended to said buyer, and the step of electronically providing payment to said fuel merchant includes borrowing against said line of credit.

23. The transaction system of claim 18, wherein a testing services agreement sets forth testing procedures whereby said bunker surveyor receives said fuel test sample and a bunker delivery note corresponding to said bunker order, tests the fuel test sample including determining said measurement of said at least one bunker factor, and determining whether said measurement satisfies said predetermined criterion.

24. The transaction system of claim 18, wherein the transaction processing system is configured to receive a fuel quantity survey assessing the amount of fuel supplied at the fuel delivery to the buyer.
